(19) United States
(12) Patent Application Publication
(10) Pub. No.: US 2023/0361922 A1
(43) Pub. Date: Nov. 9, 2023

(54) DATA TRANSMISSION METHOD AND APPARATUS

(71) Applicant: HUAWEI TECHNOLOGIES CO., LTD., Shenzhen (CN)

(72) Inventors: Ying CHEN, Hangzhou (CN); Yunfei QIAO, Hangzhou (CN); Yinggang DU, Shenzhen (CN); Hejia LUO, Hangzhou (CN); Jun WANG, Hangzhou (CN)

(21) Appl. No.: 18/352,864

(22) Filed: Jul. 14, 2023

Related U.S. Application Data
(63) Continuation of application No. PCT/CN2021/141499, filed on Dec. 27, 2021.

(30) Foreign Application Priority Data
Jan. 15, 2021 (CN) 202110055450.0

(51) Int. Cl. H04L 1/08; H04L 1/1812

(52) U.S. Cl. CPC H04L 1/08; H04L 1/1812

(57) ABSTRACT

The present disclosure relates to data transmission methods and apparatuses. In one example method, a receiving end obtains a transmission resource, and feeds back first information to a transmitting end based on the transmission resource. The first information is determined based on a channel state of a first channel, and the first information indicates whether retransmission is required or indicates whether a transmission mode is to be adjusted.

### CROSS-REFERENCE TO RELATED APPLICATIONS

This application is a continuation of International Application No. PCT/CN2021/141499, filed on Dec. 27, 2021, which claims priority to Chinese Patent Application No. 202110055450.0, filed on Jan. 15, 2021. The disclosures of the aforementioned applications are hereby incorporated by reference in their entireties.

### TECHNICAL FIELD

Embodiments of this application relate to the field of communication technologies, and in particular, to a data transmission method and apparatus.

### BACKGROUND

Non-terrestrial network communication, such as satellite communication, has a long communication distance, and a loss introduced by path propagation is far greater than that introduced by terrestrial communication. Therefore, it is necessary to enhance reliability of data transmission.

In the conventional art, a hybrid automatic repeat request (hybrid automatic repeat request, HARQ) manner is usually used in the terrestrial communication to improve the reliability of the data transmission. In the HARQ, a stop-and-wait protocol is used for sending data. To be specific, each time after a transmitting end sends data, the transmitting end needs to wait for confirmation information fed back by a receiving end after the receiving end decodes the data, and then determines whether to retransmit the data. In a long-distance communication scenario such as satellite communication or high-altitude platform communication, a communication delay is large. Therefore, if a conventional retransmission technology is used, the communication delay is increased, and a throughput of a non-terrestrial communication system such as a satellite communication system is reduced.

### SUMMARY

This application provides a data transmission method and apparatus, to reduce a communication delay and enhance reliability of data transmission.

According to a first aspect, this application provides a data transmission method. The method is applied to a receiving end and includes: obtaining a transmission resource; and feeding back first information to a transmitting end based on the transmission resource, where the first information is determined based on a channel state of a first channel, and the first information indicates whether retransmission is required or indicates whether a transmission mode is to be adjusted.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, before the feeding back first information to a transmitting end based on the transmission resource, the method further includes: obtaining second information from the transmitting end, where the second information indicates that the transmission resource is to be activated for feedback.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

In an optional implementation, the feeding back first information to a transmitting end based on the transmission resource includes: in a first time period, feeding back the first information to the transmitting end based on the transmission resource, where the first time period indicates effective duration in which the transmission resource is used for feeding back the first information.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

In an optional implementation, the method further includes: obtaining first data from the transmitting end through the first channel, where the first data is related to a first hybrid automatic repeat request HARQ process, and the first HARQ process is in a disabled state; and measuring the channel state of the first channel based on the obtained first data, and determining the first information based on a measurement result, where the first information is used by the transmitting end for determining a transmission mode of to-be-sent second data, and the second data is related to the first HARQ. Optionally, the transmission mode of the second data includes at least one of the following: repeated transmission and aggregation transmission.

In this embodiment of this application, data transmission in the disabled HARQ is enhanced, to resist a decoding error caused by a channel burst. This is applicable to a non-terrestrial network communication scenario.

In an optional implementation, the method further includes: obtaining third data from the transmitting end through the first channel, where the third data is related to a second hybrid automatic repeat request HARQ process, and the second HARQ process is in an enabled state; and measuring the channel state of the first channel based on the obtained third data, and determining the first information based on a measurement result, where the first information is used by the transmitting end for determining whether to retransmit the third data. The first information is fed back before a decoding result is obtained, so that the transmitting end may determine, in advance based on the first information, whether to perform the retransmission, without waiting for an ACK/NACK indicating whether to perform the retransmission. This reduces the communication delay.

According to a second aspect, this application provides a data transmission method. The method is applied to a transmitting end and includes: obtaining first information from a receiving end based on a transmission resource, where the first information is determined based on a channel state of a first channel, the first information indicates whether retransmission is required or indicates whether a transmission mode is to be adjusted, and the transmission resource is used for feeding back the first information; and determining, based on the first information, whether to perform the retransmission or to adjust the transmission mode on the first channel.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, before the obtaining first information from a receiving end based on a transmission resource, the method further includes: sending second information to the receiving end, where the second information indicates that the transmission resource is to be activated for feedback.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

In an optional implementation, the obtaining first information from a receiving end based on a transmission resource includes: in a first time period, obtaining the first information from the receiving end based on the transmission resource, where the first time period indicates effective duration in which the transmission resource is used for feeding back the first information.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

In an optional implementation, the method further includes: before the obtaining first information from a receiving end, sending first data to the receiving end through the first channel, where the first data is related to a first hybrid automatic repeat request HARQ process, and the first HARQ process is in a disabled state; and the first information is used by the transmitting end for determining a transmission mode of to-be-sent second data, and the second data is related to the first HARQ. Optionally, the transmission mode of the second data includes at least one of the following: repeated transmission and aggregation transmission.

In this embodiment of this application, data transmission in the disabled HARQ is enhanced, to resist a decoding error caused by a channel burst. This is applicable to a non-terrestrial network communication scenario.

In an optional implementation, the method further includes: before the obtaining first information from a receiving end, sending third data to the receiving end through the first channel, where the third data is related to a second hybrid automatic repeat request HARQ process, and the second HARQ process is in an enabled state; and the first information is used by the transmitting end for determining whether to retransmit the third data. The first information is fed back before a decoding result is obtained, so that the transmitting end may determine, in advance based on the first information, whether to perform the retransmission, without waiting for an ACK/NACK indicating whether to perform the retransmission. This reduces the communication delay.

According to a third aspect, this application provides a data transmission apparatus. The apparatus is used in a receiving end and includes: a communication module, configured to obtain a transmission resource; and a processing module, configured to determine first information. The first information is determined based on a channel state of a first channel. The first information indicates whether retransmission is required or indicates whether a transmission mode is to be adjusted. The communication module is further configured to feed back the first information to a transmitting end based on the transmission resource.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, before feeding back the first information to the transmitting end based on the transmission resource, the communication module is further configured to: obtain second information from the transmitting end, where the second information indicates that the transmission resource is to be activated for feedback.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

In an optional implementation, the communication module is specifically configured to: in a first time period, feed back the first information to the transmitting end based on the transmission resource, where the first time period indicates effective duration in which the transmission resource is used for feeding back the first information.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

In an optional implementation, the communication module is further configured to obtain first data from the transmitting end through the first channel, where the first data is related to a first hybrid automatic repeat request HARQ process, and the first HARQ process is in a disabled state. The processing module is further configured to measure the channel state of the first channel based on the obtained first data, and determine the first information based on a measurement result, where the first information is used by the transmitting end for determining a transmission mode of to-be-sent second data, and the second data is related to the first HARQ. Optionally, the transmission mode of the second data includes at least one of the following: repeated transmission and aggregation transmission.

In this embodiment of this application, data transmission in the disabled HARQ is enhanced, to resist a decoding error caused by a channel burst. This is applicable to a non-terrestrial network communication scenario.

In an optional implementation, the communication module is further configured to obtain third data from the transmitting end through the first channel, where the third data is related to a second hybrid automatic repeat request HARQ process, and the second HARQ process is in an enabled state. The processing module is further configured to measure the channel state of the first channel based on the obtained third data, and determine the first information based on a measurement result, where the first information is used by the transmitting end for determining whether to retransmit the third data. The first information is fed back before a decoding result is obtained, so that the transmitting end may determine, in advance based on the first information, whether to perform the retransmission, without waiting for an ACK/NACK indicating whether to perform the retransmission. This reduces the communication delay.

According to a fourth aspect, this application provides a data transmission apparatus. The apparatus is used in a transmitting end and includes: a communication module, configured to obtain first information from a receiving end based on a transmission resource, where the first information is determined based on a channel state of a first channel, the first information indicates whether retransmission is required or indicates whether a transmission mode is to be adjusted, and the transmission resource is used for feeding back the first information; and a processing module, further configured to determine, based on the first information, whether to perform the retransmission or to adjust the transmission mode on the first channel.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, before obtaining the first information from the receiving end based on the transmission resource, the communication module is further configured to: send second information to the receiving end, where the second information indicates that the transmission resource is to be activated for feedback.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

In an optional implementation, the communication module is specifically configured to: in a first time period, obtain the first information from the receiving end based on the transmission resource, where the first time period indicates effective duration in which the transmission resource is used for feeding back the first information.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

In an optional implementation, the communication module is further configured to: before obtaining the first information from the receiving end, send first data to the receiving end through the first channel, where the first data is related to a first hybrid automatic repeat request HARQ process, and the first HARQ process is in a disabled state; and the first information is used by the transmitting end for determining a transmission mode of to-be-sent second data, and the second data is related to the first HARQ. Optionally, the transmission mode of the second data includes at least one of the following: repeated transmission and aggregation transmission.

In this embodiment of this application, data transmission in the disabled HARQ is enhanced, to resist a decoding error caused by a channel burst. This is applicable to a non-terrestrial network communication scenario.

In an optional implementation, the communication module is further configured to: before obtaining the first information from the receiving end, send third data to the receiving end through the first channel, where the third data is related to a second hybrid automatic repeat request HARQ process, and the second HARQ process is in an enabled state; and the first information is used by the transmitting end for determining whether to retransmit the third data. The first information is fed back before a decoding result is obtained, so that the transmitting end may determine, in advance based on the first information, whether to perform the retransmission, without waiting for an ACK/NACK indicating whether to perform the retransmission. This reduces the communication delay.

According to a fifth aspect, this application provides a communication apparatus, including: a logic circuit and an input/output interface. The input/output interface is configured to input a transmission resource. The logic circuit is configured to determine first information. The first information is determined based on a channel state of a first channel. The first information indicates whether retransmission is required or indicates whether a transmission mode is to be adjusted. The input/output interface is further configured to output the first information through the transmission resource.

According to a sixth aspect, this application provides a communication apparatus, including: a logic circuit and an input/output interface. The input/output interface is configured to input first information through a transmission resource. The first information is determined based on a channel state of a first channel. The first information indicates whether retransmission is required or indicates whether a transmission mode is to be adjusted. The transmission resource is used for feeding back the first information. The logic circuit is configured to determine, based on the first information, whether to perform the retransmission or to adjust the transmission mode on the first channel.

In any optional implementation according to the first aspect to the sixth aspect, the first information includes at least one of the following: first indication information and second indication information. The first indication information indicates a channel condition of the first channel, and the second indication information indicates a modulation and coding scheme MCS or a variation value of an MCS.

In any optional implementation of the first aspect to the sixth aspect, the channel condition of the first channel is related to a deterioration degree of the channel state of the first channel. If the deterioration degree of the channel state of the first channel exceeds a specified threshold, the channel condition of the first channel is poor. Alternatively, if the deterioration degree of the channel state of the first channel does not exceed a specified threshold, the channel condition of the first channel is good. The feedback is performed in advance to briefly indicate the good or poor channel condition to the transmitting end. Therefore, efficiency of determining the transmission mode by the transmitting end can be further improved. For example, an adjustment is implemented in advance, and the communication delay is reduced.

In any optional implementation of the first aspect to the sixth aspect, the channel condition of the first channel is a channel condition level that is in a preset range of channel condition levels and that is related to the deterioration degree of the state of the first channel. The preset range of channel condition levels includes a plurality of channel condition levels, and different channel condition levels are associated with different deterioration degrees of the channel state. The channel condition levels are classified, so that different transmission modes are used for different channel conditions. This is more suitable for measuring the channel state, and data transmission can be effectively enhanced.

According to a seventh aspect, this application provides a communication apparatus, including a processor. The processor is coupled to a memory. The memory is configured to store a computer program or instructions. The processor is configured to execute the computer program or the instructions to implement the implementation methods according to the first aspect or the second aspect. The memory may be located inside or outside the apparatus. There are one or more processors.

According to an eighth aspect, this application provides a communication apparatus, including a processor and an interface circuit. The interface circuit is configured to communicate with another apparatus. The processor is configured to perform the implementation methods according to the first aspect or the second aspect.

According to a ninth aspect, this application provides a communication system, including a network device configured to perform the implementation methods according to the first aspect and a terminal device configured to perform the implementation methods according to the second aspect.

According to a tenth aspect, this application further provides a chip system, including a processor, configured to perform the implementation methods according to the first aspect or the second aspect.

According to an eleventh aspect, this application further provides a computing program product, including computer-executable instructions. When the computer-executable instructions are run on a computer, the implementation methods according to the first aspect or the second aspect are implemented.

According to a twelfth aspect, this application further provides a computer-readable storage medium. The computer-readable storage medium stores a computer program or instructions. When the instructions are run on a computer, the implementation methods according to the first aspect or the second aspect are implemented.

For technical effects that can be achieved in the fifth aspect to the tenth aspect, refer to descriptions of technical effects that can be brought by the corresponding technical solutions in the first aspect and the second aspect. Details are not described herein again.

### BRIEF DESCRIPTION OF DRAWINGS

FIG. 1 is a schematic flowchart of HARQ transmission;

FIG. 2 is a schematic diagram of transmission of parallel HARQ processes;

FIG. 3 is a schematic diagram of an architecture of a communication system according to an embodiment of this application;

FIG. 4 is a schematic diagram of an architecture of another communication system according to an embodiment of this application;

FIG. 5 is a schematic flowchart 1 of a data transmission method according to an embodiment of this application;

FIG. 6 is a schematic diagram of transmission resource distribution according to an embodiment of this application;

FIG. 7 is a schematic flowchart 2 of a data transmission method according to an embodiment of this application;

FIG. 8a is a schematic flowchart 2 of the data transmission method according to an embodiment of this application;

FIG. 8b is a schematic flowchart 2 of the data transmission method according to an embodiment of this application;

FIG. 9 is a schematic flowchart 3 of a data transmission method according to an embodiment of this application;

FIG. 10a is a schematic flowchart 2 of the data transmission method according to an embodiment of this application;

FIG. 10b is a schematic flowchart 2 of the data transmission method according to an embodiment of this application;

FIG. 11 is a schematic flowchart 4 of a data transmission method according to an embodiment of this application;

FIG. 12 is a block diagram of a structure of a data transmission apparatus according to an embodiment of this application;

FIG. 13 is a schematic diagram of a structure of a communication apparatus according to an embodiment of this application; and

FIG. 14 is a schematic diagram of a structure of another communication apparatus according to an embodiment of this application.

### DESCRIPTION OF EMBODIMENTS

Embodiments of this application can be applied to a non-terrestrial network (non-terrestrial network, NTN), a 4G network, a 5G network, a future communication network, or the like.

“A plurality of” mentioned in embodiments of this application means two or more. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, it should be understood that although terms such as “first” and “second” may be used in embodiments of the present invention to describe objects, these objects are not limited by these terms. These terms are merely used to distinguish the objects from each other.

Terms “including”, “having”, and any other variant thereof mentioned in descriptions of embodiments of this application are intended to cover a non-exclusive inclusion. For example, a process, a method, a system, a product, or a device that includes a series of steps or units is not limited to the listed steps or units, but optionally further includes other unlisted steps or units, or optionally further includes another inherent step or unit of the process, the method, the product, or the device. It should be noted that, in embodiments of this application, the word “example” or “for example” is used to represent giving an example, an illustration, or a description. Any embodiment or design scheme described as an “example” or “for example” in embodiments of this application should not be explained as being more preferred or having more advantages than another embodiment or design scheme. To be precise, the word such as “example” or “for example” is intended to present a related concept in a specific manner.

The following briefly describes a conventional technology related to data transmission enhancement.

In a HARQ technology, a receiving end stores an obtained error data packet in a HARQ buffer (buffer), and combines the error data packet with a retransmitted data packet that is subsequently obtained, to obtain a data packet that is more reliable than a data packet that is decoded separately. This is a soft combining process. Then, the receiving end decodes the data packet obtained through the combining. If decoding still fails, a procedure of “requesting retransmission, and then performing the soft combining” is repeated.

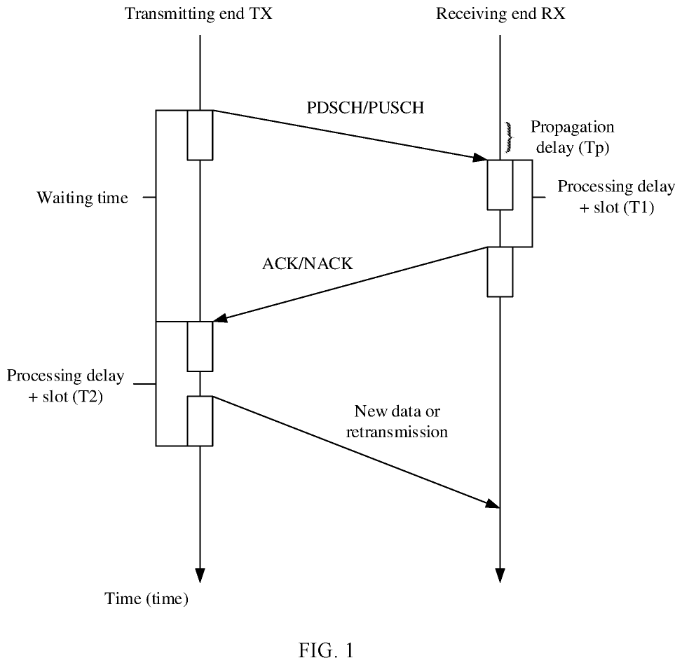

The HARQ determines, through CRC verification, whether an error exists in the obtained data packet. The CRC verification is performed after the soft combining. If the CRC verification succeeds, the receiving end sends a positive feedback, that is, a positive acknowledgment character (acknowledgment, ACK). If the CRC verification fails, the receiving end sends a negative feedback, that is, a negative acknowledgment character (negative Acknowledgment, NACK). FIG. 1 is a schematic flowchart of HARQ transmission. A HARQ procedure includes the following steps (steps).
Step 1: A transmitting end sends data to a receiving end.
Step 2: The receiving end decodes the received data.
Step 3: The receiving end feeds back an ACK/NACK to the transmitting end based on a decoding result. When the decoding is correct, the receiving end feeds back the ACK. When the decoding is incorrect, the receiving end feeds back the NACK.
Step 4: After the transmitting end obtains the ACK/NACK, if obtaining the NACK, the transmitting end retransmits the data to the receiving end, and if obtaining the ACK, the transmitting end does not retransmit the data to the receiving end.

In addition, it should be noted that in the HARQ, a stop-and-wait protocol (stop-and-wait protocol) is used for sending the data. Specifically, in the stop-and-wait protocol, after sending a data packet such as a TB, the transmitting end stops and waits for confirmation information. The receiving end performs, by using 1-bit information, an acknowledgment (ACK) or a negative acknowledgment (NACK) on the data packet. However, each time transmission is performed, the transmitting end stops and waits for the confirmation. Consequently, a throughput is low. Therefore, when a plurality of parallel stop-and-wait processes are used and wait for confirmation information, the transmitting end may continue to send data by using another HARQ process (process), so that the data can be continuously transmitted.

Each HARQ process requires an independent HARQ buffer at the receiving end, to perform the soft combining on the received data.

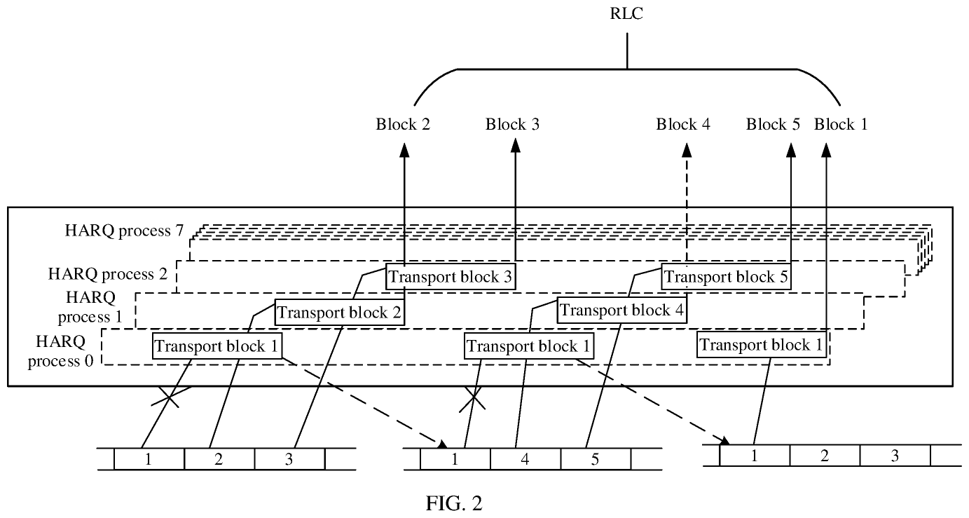

Using the plurality of parallel stop-and-wait processes may cause out-of-order data sent from a media access control (medium access control, MAC) layer to a radio link control (radio link control, RLC) layer of the receiving end. As shown in the schematic diagram of transmission of parallel HARQ processes in FIG. 2, a transport block (transmission block, TB) 5 is successfully decoded before a transport block 1. As a result, the transport block 5 is sent to the RLC layer before the transport block 1, and data is out of order. Therefore, the received data needs to be reordered at the RLC layer. In carrier aggregation, the RLC layer needs to be responsible for reordering of all the data (blocks 1 to 5 shown in FIG. 2). This is because the RLC layer is invisible to the carrier aggregation, and each carrier unit is provided with an independent HARQ entity. As a result, one RLC layer needs to receive data from a plurality of HARQ entities, and the data received from the plurality of HARQ entities may be out of order.

Therefore, after receiving one piece of confirmation information (ACK/NACK), the transmitting end needs to know a HARQ process corresponding to the confirmation information. This is determined by using a fixed slot relationship between the confirmation information and the transmitted data. For the HARQ, it makes sense to discuss “initial transmission” and “retransmission” only when the “initial transmission” and “retransmission” correspond to same data (or transport block), namely, the same HARQ process.

In addition, the HARQ is classified into a downlink HARQ and an uplink HARQ. The downlink HARQ is for downlink shared channel data, and the uplink HARQ is for uplink shared channel data. The downlink HARQ and the uplink HARQ are independent of each other, and processing manners are different. In a conventional technology, asynchronous HARQ transmission is used in both uplink and downlink. To be specific, the retransmission may occur at any moment, and the HARQ processes can be used in any order.

In conclusion, in the HARQ technology, the stop-and-wait protocol is used for sending data. To be specific, each time after the transmitting end sends the data, the transmitting end needs to wait for the confirmation information fed back by the receiving end after the receiving end decodes the data, and then determines whether to retransmit the data. In a long-distance communication scenario such as satellite communication or high-altitude platform communication, a communication delay is large. Therefore, if a conventional retransmission technology is used, the communication delay is increased, and a throughput of a non-terrestrial communication system such as a satellite communication system is reduced.

On this basis, an embodiment of this application provides a data transmission method. A specific transmission resource is configured, so that a receiving end feeds back information related to a channel state to a transmitting end. Before receiving feedback obtained after data decoding, the transmitting end may determine a data transmission mode based on the information related to the channel state. The method can reduce a communication delay, be applied to a non-terrestrial communication system, and improve a throughput of the non-terrestrial communication system. Optionally, the transmitting end in this embodiment of this application may be a base station, and the receiving end may be a terminal device. Alternatively, the transmitting end in this embodiment of this application may be a terminal device, and the receiving end may be a base station.

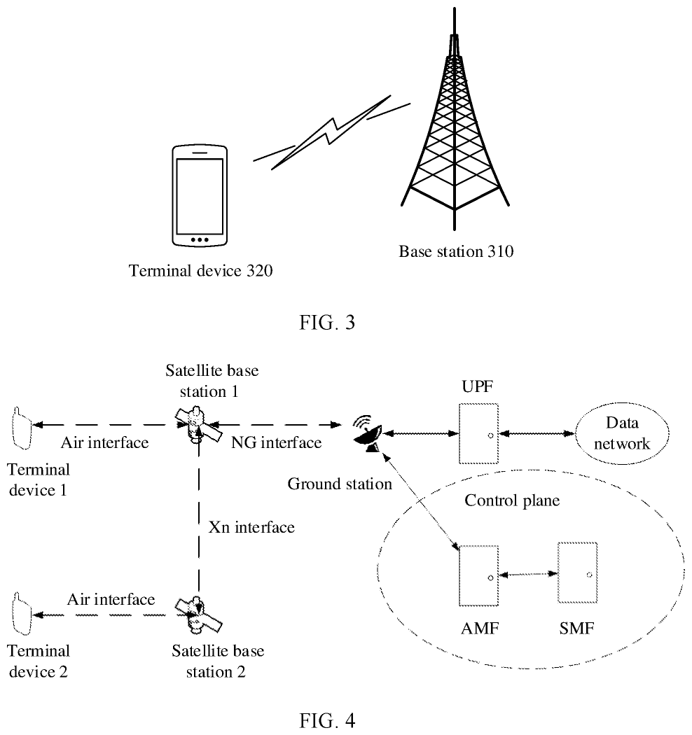

The data transmission method provided in this embodiment of this application may be applied to a communication system 300 shown in FIG. 3. The communication system 300 includes a base station 310 and a terminal device 320. In a specific implementation procedure of this embodiment of this application, the terminal device 320 may include various handheld devices, vehicle-mounted devices, wearable devices, or computing devices that have a wireless communication function, or other processing devices connected to a wireless modem. The terminal device may be a mobile station (mobile station, MS), a subscriber unit (subscriber unit), a cellular phone (cellular phone), a smartphone (smart phone), a wireless data card, a personal digital assistant (personal digital assistant, PDA) computer, a tablet computer, a wireless modem (modem), a handset (handset), a laptop computer (laptop computer), a machine type communication (machine type communication, MTC) terminal device, an uncrewed aerial vehicle, or the like. This is not limited in this embodiment of this application. The base station 310 may be a terrestrial base station or a non-terrestrial base station. The terrestrial base station includes but is not limited to a base station on the ground and a base station on a high mountain or in water. The non-terrestrial base station includes but is not limited to a satellite base station, a hot air balloon that can implement a base station function, a high-altitude platform, also referred to as a flying platform, an uncrewed aerial vehicle, or the like. The base station provides a radio access service, schedules radio resources for an access terminal, and provides a reliable radio transmission protocol, a reliable data encryption protocol, and the like. It should be noted that, in actual application, there may be one or more base stations and terminal devices. Quantities and types of base stations and terminal devices in the communication system shown in FIG. 3 are merely adaptive examples. This is not limited in this application.

The communication system may be a long term evolution (long term evolution, LTE) system that supports a fourth generation (fourth generation, 4G) access technology, a new radio (new radio, NR) system that supports a fifth generation (fifth generation, 5G) access technology, or a new radio vehicle-to-everything (vehicle to everything, NR V2X) system. The communication system may be used in a system in hybrid networking of LTE and 5G, a device-to-device (device-to-device, D2D) communication system, a machine-to-machine (machine to machine, M2M) communication system, internet of things (internet of Things, IoT), an uncrewed aerial vehicle communication system, a communication system that supports a plurality of wireless technologies, for example, an LTE technology and an NR technology, or a non-terrestrial communication system, for example, a satellite communication system or a high-altitude communication platform. In addition, the communication system is optionally applicable to a narrowband-internet of things (narrowband-internet of things, NB-IoT) system, an enhanced data rate for GSM evolution (enhanced data rate for GSM evolution, EDGE) system, a wideband code division multiple access (wideband code division multiple access, WCDMA) system, a code division multiple access 2000 (code division multiple access, CDMA 2000) system, a time division-synchronous code division multiple access (time division-synchronization code division multiple access, TD-SCDMA) system, a long term evolution (long term evolution, LTE) system, and a future-oriented communication technology.

The non-terrestrial communication system is used as an example for description. Refer to FIG. 4. This embodiment of this application further provides a communication system 400. The communication system includes a satellite base station, a terminal device, and a terrestrial station. The terminal device may communicate with the satellite base station through an air interface, and may access a satellite network through the air interface, and initiate a service such as a call or internet access. The terrestrial station may be disposed on the ground. The terminal device and the terrestrial station may communicate with each other by forwarding a signal by using the satellite base station. The satellite base station may communicate with the terrestrial station through an NG interface, and the terrestrial station is responsible for forwarding signaling and service data between the satellite base station and a core network. In addition, when the communication system includes a plurality of satellite base stations, the satellite base stations may communicate with each other through an Xn interface, for example, exchanging handover-related signaling. A communication link between the satellite base station and the terminal device may be referred to as a service link, and a communication link between the satellite base station and the terrestrial station may be referred to as a feed link. For example, FIG. 4 shows one terrestrial station, two satellite base stations, namely, a satellite base station 1 and a satellite base station 2, and two terminal devices, namely, a terminal device 1 and a terminal device 2. The terminal device 1 communicates with the satellite base station 1 through an air interface. The satellite base station 1 communicates with the terrestrial station through an NG interface. The satellite base station 1 communicates with the satellite base station 2 through an Xn interface. The satellite base station 2 communicates with the terminal device 2 through an air interface. The foregoing air interface may be an air interface of any type, for example, a 5G air interface.

The terrestrial station may be any device having a wireless transceiver function, and is mainly configured to implement functions such as a wireless physical control function and functions such as resource scheduling, radio resource management, wireless access control, and mobility management, to provide the reliable radio transmission protocol, the reliable data encryption protocol, and the like. Specifically, the terrestrial station may alternatively be an access network device, and the access network device may be a device supporting wired access, or may be a device supporting wireless access. For example, the terrestrial station may be an access network (access network, AN)/radio access network (radio access network, RAN) device, and includes a plurality of 5G-AN/5G-RAN nodes. The 5G-AN/5G-RAN node may be an access point (access point, AP), a base station (nodeB, NB), an enhanced base station (enhanced nodeB, eNB), a next-generation base station (NR nodeB, gNB), a transmission and reception point (transmission and reception point, TRP), a transmission point (transmission point, TP), another access node, or the like. In addition, it should be noted that the terrestrial station may also be described as a gateway station. This is not limited in this embodiment of this application.

The satellite base station may alternatively be another flying platform, also referred to as a high-altitude platform, for example, an uncrewed aerial vehicle or a hot air balloon that can implement a base station function. For example, the flying platform may include a low-earth orbit satellite, a medium-earth orbit satellite, a geosynchronous orbit satellite, an uncrewed flying system platform, or a high-earth orbit satellite based on an altitude of the aircraft platform.

Compared with terrestrial communication, satellite communication has unique advantages. For example, the satellite communication is capable of providing a wider coverage range, and a satellite is not vulnerable to a natural disaster or external force. Therefore, the satellite communication is capable of providing a communication service for some areas, such as an ocean or a forest, that cannot be covered by a terrestrial communication network, to enhance reliability of a communication system. In this way, for example, a better communication service can be provided for aircrafts, trains, and terminal devices on these transportation vehicles. More data transmission resources are provided for the communication system, to improve a network rate. Therefore, a communication system that supports both the terrestrial communication and the satellite communication has advantages such as a wide coverage, high reliability, multi-connection, and a high throughput.

In addition, the communication system 400 may further include a core network device and a data network (data network, DN). The terminal device may communicate with the data network through the satellite base station, the terrestrial station, and the core network device.

The core network device may be configured to send, to the data network, data that is of the terminal device and that is sent by the satellite base station/the terrestrial station. The core network device may be configured to implement services such as user access control, mobility management, session management, user security authentication, and charging. The core network device may include a plurality of functional units. For example, the core network device may be classified into a control-plane functional entity and a data-plane functional entity. The control-plane functional entity may include an access and mobility management unit (access and mobility management function, AMF), a session management unit (session management function, SMF), and the like. The data-plane functional entity may include a user plane unit (user plane function, UPF), and the like. For example, FIG. 4 shows a data-plane functional entity UPF and control-plane functional entities AMF and SMF.

The access and mobility management unit is mainly responsible for work such as access authentication and mobility management of user equipment, and signaling interaction between functional network elements, for example, managing a registration status of a user, a connection status of the user, user registration and network access, tracking area update, user authentication during cell handover, and key security.

The session management unit may be referred to as a session management function, a multicast/broadcast-service management function (multicast/broadcast-service management function, MB-SMF), a multicast session management network element, or the like. This is not limited. The session management network element is mainly configured to implement a user plane transmission logical channel, for example, session management functions such as establishment, release, and modification of a packet data unit (packet data unit, PDU) session.

The user plane unit may further be referred to as a PDU session anchor (PSF), a user plane function, or a multicast/broadcast user plane function (multicast/broadcast user plane function, MB-UPF). The user plane network element may be used as an anchor on the user plane transmission logical channel, and is mainly configured to complete functions such as routing and forwarding of user plane data. For example, the user plane network element establishes a channel (namely, the user plane transmission logical channel) to the terminal, forwards, on the channel, a data packet between the terminal device and the DN, and is responsible for data packet filtering, data forwarding, rate control, generation of charging information, traffic statistics, security interception, and the like for the terminal. A multicast/broadcast (multicast/broadcast, MB) service controller (MB service controller) has service management functions such as group management, security management, and service announcement.

It should be noted that, other than the foregoing units, the core network device may further include a policy control unit (policy control function, PCF), an application function (application function, AF) unit, and the like. This is not limited.

The data network may be an operator network that provides a data transmission service for the terminal device, for example, an operator network that provides an IP multimedia service (IP multimedia service, IMS) for the terminal device. An application server (application server, AS) may be deployed in the DN, and the application server may provide the data transmission service for the terminal device.

The data transmission method provided in this embodiment of this application is applied to a long-distance communication scenario, for example, applied to a satellite communication scenario in which a distance between the terminal device and the network device continuously changes, or another long-distance communication scenario. This is not limited.

The following describes in detail the data transmission method provided in this embodiment of this application.

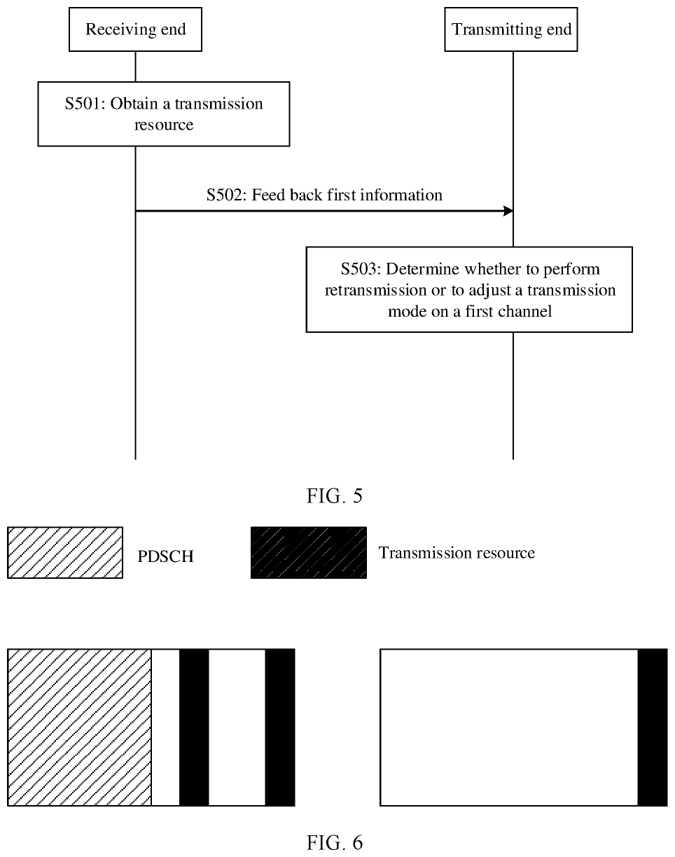

Refer to a data transmission method shown in FIG. 5. The method includes the following steps.

S501: A receiving end obtains a transmission resource, where the transmission resource may be used for feeding back information related to a channel state and/or a data transmission mode in advance.

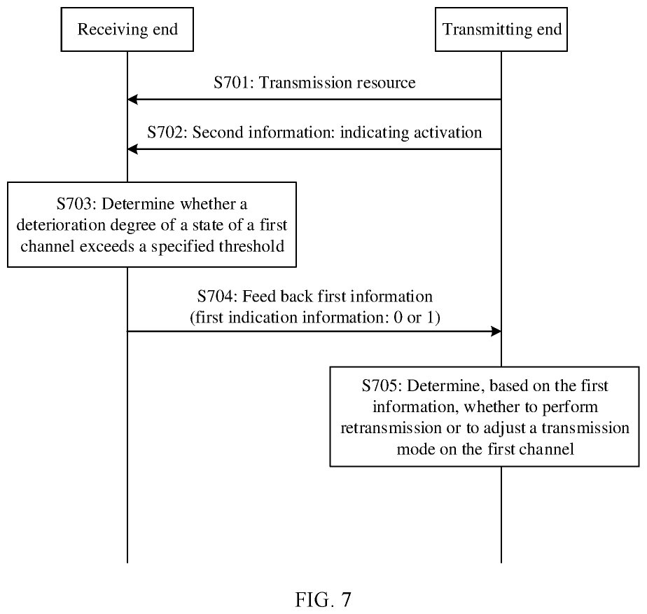

In an optional implementation, the transmission resource may be indicated to the receiving end by a transmitting end. For example, the transmitting end sends a first message to the receiving end, where the first message carries indication information indicating the transmission resource. Optionally, if the transmitting end is a base station and the receiving end is a terminal device, the transmitting end may indicate the transmission resource to the receiving end through RRC signaling, where the transmission resource includes a time domain resource and a frequency domain resource. In another optional implementation, the transmission resource may be pre-configured. Optionally, the transmission resource may be an uplink transmission resource or a periodically allocated uplink transmission resource. For example, if the receiving end is a terminal device, and the transmitting end is a base station, the transmission resource may be a part of PUSCH-related transmission resources. As shown in FIG. 6, the transmission resource may be periodically distributed.

In addition, optionally, the transmitting end may also indicate a feedback manner to the receiving end through the RRC signaling. For example, the feedback manner is one or more of the following: a quantity of times of repeatedly feeding back information by the receiving end, and a modulation and coding scheme MCS used by the receiving end for feeding back the information. Specifically, the transmitting end may add a report configuration field (for example, ConfiguredReportConfig) to the RRC signaling. The report configuration field may define the following information elements, including defining mcs-Table ENUMERATED {qam256, gam64LowSE}, which is interpreted as an MCS used for performing the feedback in advance; and defining repK ENUMERATED {n1, n2, n4, n8}, which is interpreted as performing the feedback in advance for one time, two times, four times, or eight times repeatedly. The transmitting end may indicate the feedback manner and the transmission resource through the same RRC signaling. Optionally, the foregoing report configuration field may further define the following information element: defining resourceAllocation, which is interpreted as resource allocation, namely, the transmission resource, for feedback in advance.

S502: The receiving end feeds back first information to the transmitting end based on the transmission resource, and the transmitting end obtains the first information from the receiving end based on the transmission resource. The first information is determined based on a channel state of a first channel, and the first information indicates whether retransmission is required or indicates whether a transmission mode is to be adjusted. The first channel is a channel for transmitting data between the transmitting end and the receiving end.

Optionally, when the transmitting end indicates the feedback manner to the receiving end, the receiving end may feed back the first information in the feedback manner indicated by the transmitting end. For example, the first information is repeatedly fed back based on the quantity of times of repeatedly feeding back information by the receiving end. For example, a modulation and coding scheme MCS used for the first information is determined based on the MCS used by the receiving end for feeding back the information. This can enhance transmission of the information fed back in advance, to reduce a probability of a decoding error on the transmitting end side, and avoid a misjudgment. If the transmitting end is the base station, and the receiving end is the terminal device, signaling such as PUSCH signaling and UCI signaling of the terminal device may include the first information, and the signaling is sent to the transmitting end, to feed back the first information to the transmitting end.

S503: The transmitting end determines, based on the first information, whether to perform the retransmission or to adjust the transmission mode on the first channel. It should be noted that this step is an optional step. After obtaining the first information, the transmitting end may perform or may not perform this step. This is not limited in this embodiment of this application.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, activation/deactivation of the transmission resource may be configured. In a case of the activation, the terminal device may perform the feedback based on the transmission resource. In a case of the deactivation, the terminal device cannot perform the feedback based on the transmission resource. The following describes two solutions for configuring the activation/deactivation of the transmission resource provided in this embodiment of this application.

Solution 1: The transmitting end may control the activation/deactivation of the transmission resource.

Optionally, the transmitting end may generate second information indicating that the transmission resource is to be activated for feedback. The transmitting end sends the second information to the receiving end, to indicate that the transmitting end indicates that the receiving end may perform the feedback based on the transmission resource. Further, based on the data transmission method shown in FIG. 5, before the receiving end feeds back the first information to the transmitting end based on the transmission resource, the method may optionally further include the following step between S501 and S502: The receiving end obtains second information from the transmitting end, where the second information indicates that the transmission resource is to be activated for feedback. Optionally, if the transmitting end is the base station, and the receiving end is the terminal device, the base station may add the second information to downlink control information (downlink control information, DCI) or RRC signaling sent to the terminal device. The second information may be specifically implemented by using a flag bit (flag). For example, a first flag bit is added to the DCI or the RRC. If a value of the first flag bit is 1, it indicates that the transmission resource is to be activated.

Similarly, the transmitting end may generate third information indicating that the transmission resource is to be deactivated. The transmitting end sends the third information to the receiving end, to indicate that the transmitting end notifies the receiving end that the transmission resource is to be deactivated and that the receiving end does not need to perform the feedback based on the transmission resource. Further, based on the data transmission method shown in FIG. 5, the method may further include: The transmitting end sends the third information to the receiving end, where the third information indicates that the transmission resource is to be deactivated. In this case, the receiving end may not feed back the first information or stop feeding back the first information. Optionally, if the transmitting end is the base station, and the receiving end is the terminal device, the base station may add the second information to the downlink control information (downlink control information, DCI) or the RRC signaling sent to the terminal device. The second information may be specifically implemented by using a flag bit (flag). For example, a first flag bit is added to the DCI or the RRC. If a value of the first flag bit is 0, it indicates that the transmission resource is to be deactivated.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

Solution 2: Activation/deactivation of the transmission resource may be controlled by configuring effective time of the transmission resource. For example, the transmission resource may be configured to be effective in a first time period. In the first time period, the receiving end may feed back the foregoing first information based on the transmission resource, where the first time period indicates effective duration in which the transmission resource is used for feeding back the first information. This embodiment of this application further provides the following three optional implementations for configuring the first time period.

In a first optional implementation, fixed duration may be predefined. The transmitting end may send the second information to the receiving end to notify the receiving end that the transmission resource is activated. In this case, the receiving end determines, with reference to the foregoing fixed duration, the first time period by using a time at which the receiving end obtains the second information from the transmitting end as a start time.

In a second optional implementation, the transmitting end device may send fourth information to the receiving device, where the fourth information indicates the first time period. Optionally, the fourth information includes a start time and duration of the first time period. Alternatively, optionally, the fourth information includes a start time and an end time of the first time period. Further, based on the data transmission method shown in FIG. 5, the method may further include: The transmitting end sends the fourth information to the receiving end, where the fourth information indicates the first time period, and the first time period corresponds to effective time of the transmission resource. The terminal device may feed back the first information in the first time period based on the transmission resource. Optionally, if the transmitting end is the base station, and the receiving end is the terminal device, the base station may add the fourth information to the downlink control information (downlink control information, DCI) or the RRC signaling sent to the terminal device. When the transmitting end indicates the transmission resource to the receiving end, the fourth information may also be indicated to the receiving end together with the transmission resource.

In a third optional implementation, the first time period may be predefined. For example, when the transmission resource is pre-configured, one or more of the following is defined: a start time and an end time of the first time period, and the start time and duration of the first time period.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

The following describes in detail that the transmitting end determines the transmission mode based on the first information fed back by the receiving end.

Solution (1): The first information fed back by the receiving end includes first indication information, where the first indication information indicates a channel condition of the first channel.

In an optional implementation, the channel condition of the first channel is related to a deterioration degree of a channel state of the first channel. If the deterioration degree of the channel state of the first channel exceeds a specified threshold, the channel condition of the first channel is poor. Alternatively, if the deterioration degree of the channel state of the first channel does not exceed a specified threshold, the channel condition of the first channel is good. Optionally, the first indication information included in the first information may indicate “good” or “poor”. Alternatively, optionally, a single bit may be used for representing the first indication information. For example, when the bit is 1, it indicates that the channel condition of the first channel is poor; and when the bit is 0, it indicates that the channel condition of the first channel is good. Therefore, signaling overheads can be reduced. It should be noted that, in this embodiment of this application, the feedback that the first indication information is 0 or 1 is determined by the receiving end based on the channel state. Whether the receiving end receives data is not limited. This is different from the conventional HARQ technology in which the receiving end feeds back the ACK/NACK based on the data decoding result. In addition, it should be noted that the foregoing specified threshold may be a threshold agreed upon by the transmitting end and the receiving end, or may be a threshold indicated by the transmitting end side to the receiving end.

In this case, the transmitting end may determine, based on the first indication information in the first information, whether to perform the retransmission or to adjust the transmission mode on the first channel.

In the non-terrestrial communication network, a part of HARQ processes may be configured to be enabled, and a part of HARQ processes may be configured to be disabled. Optionally, the transmitting end may determine, based on the first indication information fed back by the receiving end, whether to retransmit data of the HARQ processes in the enabled state. Optionally, the transmitting end may determine, based on the first indication information fed back by the receiving end, a transmission mode of data related to the HARQ processes in the disabled state. In addition, for the data of the enabled HARQs and the data of the disabled HARQs, there may be different determining thresholds or criteria. For example, for the foregoing specified threshold, different thresholds may be specified for the enabled HARQ processes and the disabled HARQ processes. For another example, the foregoing transmission resource may also be separately configured for the enabled HARQ processes and the disabled HARQ processes.

In this embodiment of this application, the data transmitted on the transmitting end side is also referred to as a transport block TB, and may include one or more versions. If the data of the HARQ processes in the enabled state needs to be retransmitted by the transmitting end, retransmission of one TB may be retransmitting one or more versions of the TB. Similarly, for the data of the HARQ processes in the disabled state, if the transmitting end needs to determine the transmission mode of the data related to the HARQ processes, transmission of one TB may be transmitting one or more versions of the TB. A manner of transmitting a plurality of versions of one TB together may be referred to as aggregation transmission. In addition, the transmitting end may also transmit one TB for a plurality of times in a repeated transmission mode. There may be one or more versions of the TB transmitted each time, and versions of the TB transmitted in different times may be the same or different.

For example, if the feedback received by the transmitting end indicates that the channel condition of the first channel is poor, for one TB, transmission of the TB may be enhanced in the aggregation transmission mode and the repeated transmission mode. If the feedback received by the transmitting end indicates that the channel condition of the first channel is good, a TB may be transmitted in a preset mode. It should be noted that the transmission modes are used as examples in this embodiment of this application, and do not mean that this embodiment of this application is limited thereto.

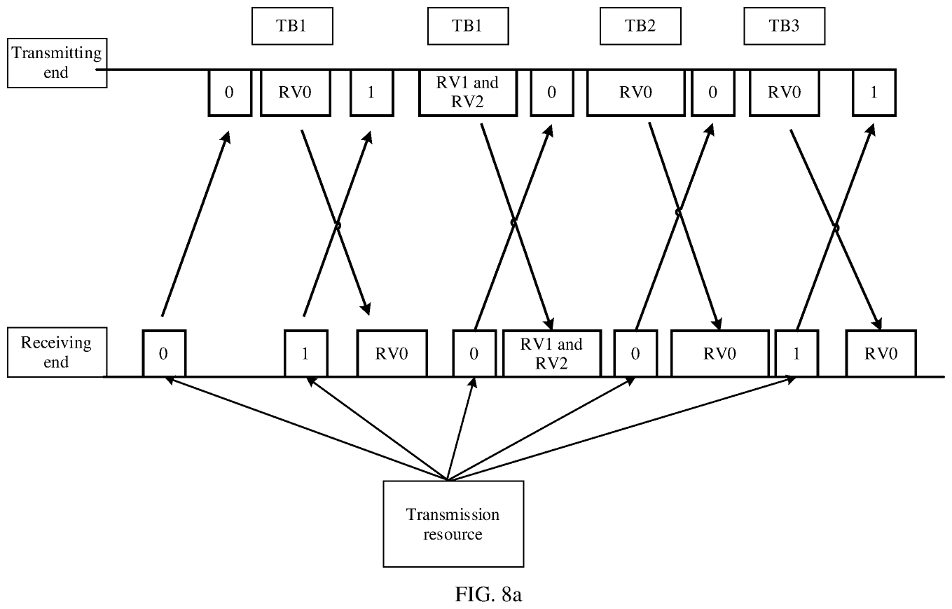

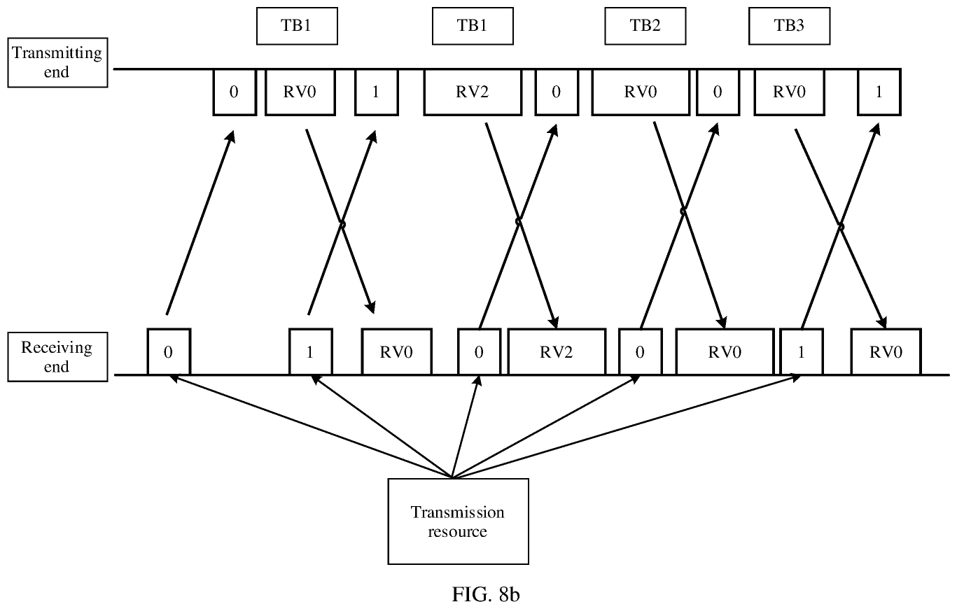

With reference to FIG. 7, FIG. 8a, and FIG. 8b, for the enabled HARQ processes and the disabled HARQ processes, the following describes in detail solutions in which the transmitting end determines the transmission mode based on the first indication information.

FIG. 7 is a flowchart of a data transmission method. The method includes the following steps.

S701: A receiving end obtains a transmission resource.

For a related implementation of the transmission resource, refer to S501. Details are not described in this embodiment of this application again. For example, FIG. 7 shows an implementation in which a transmitting end indicates the transmission resource to the receiving end.

S702: The receiving end obtains second information from the transmitting end, where the second information indicates that the transmission resource is to be activated for feedback. Optionally, S702 may not be performed, and S703 is directly performed after S701 is performed.

S703: The receiving end measures a channel state of a first channel, for example, determining whether a deterioration degree of the state of the first channel exceeds a specified threshold, and determines, based on a measurement result, first information fed back to the transmitting end, where the first information includes first indication information, and the first indication information may be 0 or 1, or the first indication information may indicate “good” or “poor”.

Optionally, if having received first data from the transmitting end through the first channel, the receiving end may measure the channel state of the first channel based on the first data. The first data is related to a first hybrid automatic repeat request HARQ process, and the first HARQ process is in a disabled state. In this case, the first information to be fed back by the receiving end may be specifically used by the transmitting end for determining a transmission mode of to-be-sent second data, and the second data is related to the first HARQ. Optionally, the second data and the first data may be a same TB, but versions or version combinations are different. Alternatively, optionally, the second data and the first data are different TBs. The transmission mode of the second data includes at least one of the following: repeated transmission and aggregation transmission.

Optionally, if the receiving end has received third data from the transmitting end through the first channel, the receiving end measures the channel state of the first channel based on the obtained third data. The third data is related to a second hybrid automatic repeat request HARQ process, and the second HARQ process is in an enabled state. In this case, the first information to be fed back by the receiving end may be specifically used by the transmitting end for determining whether to retransmit the third data. Optionally, if the third data packet includes a plurality of versions, retransmission of the third data may be transmission of a same version in previous transmission, may be aggregation transmission of a plurality of versions, or may be transmission for a plurality of times, namely, repeated transmission.

S704: The receiving end feeds back the first information to the transmitting end based on the transmission resource. As shown in FIG. 7, the first information fed back by the receiving end to the transmitting end includes a bit 0 or a bit 1. When 0 is fed back, it indicates that the channel condition of the first channel is good, and when 1 is fed back, it indicates that the channel condition of the first channel is poor.

S705: The transmitting end determines, based on the first information, whether to perform retransmission or to adjust a transmission mode on the first channel.

Optionally, the receiving end side may also determine, based on content fed back by the receiving end side or an indication from the transmitting end, whether next obtained data is retransmitted data or new data. For example, when the receiving end is a terminal, and the transmitting end is a base station, the base station may indicate, to the terminal device in the DCI, whether the next obtained data is retransmitted data or new data.

For example, FIG. 8a is a schematic diagram of data transmission. It is assumed that a TB1, a TB2, and a TB3 are data blocks, also referred to as transport blocks, that are related to a first HARQ process, and the first HARQ process is in a disabled state. When a channel condition is good, a version RV0 of data is transmitted. When the channel condition is poor, a transmission mode of to-be-sent data is enhanced, for example, versions RV1 and RV2 of same data are transmitted in an aggregated manner. As shown in FIG. 8a, when the receiving end feeds back 0 based on the transmission resource, the transmitting end sends an RV0 of the TB1. Before obtaining the RV0 of the TB1, the receiving end determines that a deterioration degree of a state of a first channel exceeds a specified threshold, and then feeds back 1 based on the transmission resource. In this case, the transmitting end transmits an RV1 and an RV2 of the TB1 in advance. Before obtaining the RV2 of the TB1, the receiving end determines that the deterioration degree of the state of the first channel does not exceed the specified threshold, and then feeds back 0 based on the transmission resource. The transmitting end then transmits an RV0 of the next data block TB2, and by analogy. FIG. 8a further shows a case in which an RV0 of the TB3 is transmitted.

For example, FIG. 8b is a schematic diagram of data block transmission. It is assumed that a TB1, a TB2, and a TB3 are data blocks (also referred to as transport blocks) related to a second HARQ, and the second HARQ process is in an enabled state. When a channel condition is good, a version RV0 of data is transmitted. When the channel condition is poor, a version RV2 of the data is retransmitted. As shown in FIG. 8b, when the receiving end feeds back 0 based on the transmission resource, the transmitting end sends an RV0 of the TB1. Before obtaining the RV0 of the TB1, the receiving end determines that a deterioration degree of a state of a first channel exceeds a specified threshold, and then feeds back 1 based on the transmission resource. In this case, the transmitting end retransmits an RV2 of the TB1 in advance. Before obtaining the RV2 of the TB1, the receiving end determines that the deterioration degree of the state of the first channel does not exceed the specified threshold, and then feeds back 0 based on the transmission resource. The transmitting end then transmits an RV0 of the next data block TB2, and by analogy. FIG. 8b further shows a case in which an RV0 of the TB3 is transmitted.

In another optional implementation, the channel condition of the first channel is a channel condition level that is in a preset range of channel condition levels and that is related to the deterioration degree of the state of the first channel. The preset range of channel condition levels includes a plurality of channel condition levels, and different channel condition levels are associated with different deterioration degrees of the channel state.

Optionally, the deterioration degree of the channel state may be measured based on the channel state. That is, a poorer channel state indicates a higher deterioration degree of the channel state. A better channel state indicates a lower deterioration degree of the channel state. The deterioration degree of the channel state may correspond to a value range obtained through quantization of the channel state, or may correspond to a specific value obtained through quantization of the channel state. This is not limited in embodiments of this application. In addition, it should be noted that the deterioration degree of the channel state may be a relative concept. For example, a current channel state being poorer than a historical channel state indicates a higher deterioration degree of the channel state. A current channel state being better than the historical channel state indicates a lower deterioration degree of the channel state. It may be understood that the higher deterioration degree of the channel state does not indicate that the current channel state has definitely deteriorated compared with the historical channel state; and the lower deterioration degree of the channel state does not mean that the channel state has definitely deteriorated, but that a deterioration degree is low.

Optionally, the deterioration degree of the channel state may be measured by using a block error rate. The block error rate herein may refer to a block error rate range that is determined by the receiving end based on averaging of historical data decoding results, or may refer to a block error rate range determined by the receiving end based on a previous data decoding result. The block error rate range may be divided into 0.0001 to 0.001, 0.001 to 0.01, 0.01 to 0.1, and the like. A smaller block error rate indicates a lower deterioration degree of the channel state, and a larger block error rate indicates a higher deterioration degree of the channel state. Similarly, it should be noted that the deterioration degree of the channel state may be a relative concept. For example, a current block error rate being smaller than a historical block error rate indicates a lower deterioration degree of the channel state, and a channel state is better than a historical channel state. A current block error rate being larger than the historical block error rate indicates a higher deterioration degree of the channel state, and a channel state is poorer than a historical channel state. It may be understood that the higher deterioration degree of the channel state does not indicate that the current channel state has definitely deteriorated compared with the historical channel state; and the lower deterioration degree of the channel state does not mean that the channel state has definitely deteriorated, but that a deterioration degree is low.

Optionally, a predefined manner may be used to configure each channel condition level in the preset range of channel condition levels to correspond to a different transmission mode. The transmission mode relates to repeated transmission, aggregation transmission, and the MCS used for transmission. Optionally, when a deterioration degree of a channel state associated with a channel condition level is low, a transmission mode corresponding to the channel condition level involves a small quantity of repeated transmissions, a small quantity of versions for the aggregation transmission, and an increase in a level of an MCS used for the transmission when the MCS is compared with an MCS corresponding to a latest CQI fed back by the receiving end. When a deterioration degree of a channel state associated with a channel condition level is high, a transmission mode corresponding to the channel condition level may involve a large quantity of repeated transmissions, a large quantity of versions for the aggregation transmission, and a decrease in a level of an MCS used for the transmission when the MCS is compared with an MCS corresponding to a latest CQI fed back by the receiving end.

For example, this embodiment of this application uses an example in which preset channel condition levels are classified into six levels. Table 1 shows configuration parameters of transmission modes corresponding to different channel condition levels, including a quantity of times of a repeated transmission mode, versions related to an aggregation transmission mode, and variation values of the MCS. Optionally, the variation value of the MCS may be set as a variation value relative to the MCS corresponding to the latest CQI fed back by the receiving end. In addition, it should be noted that the channel condition level in this embodiment of this application may be understood as an indication for the deterioration degree of the channel state or may be referred to as an index. For example, table 1 shows only an association manner in which a lower channel condition level indicates a lower deterioration degree of the channel state. Positions, numbers, and the like of the channel condition levels in table 1 may be changed. In actual application, some or all of table 1 may be used, or table 1 may be extended. This is not limited in this embodiment of this application.

TABLE 1

| Channel | Quantity of | Aggregation | MCS variation |
|---|---|---|---|
| condition level | repetitions | version | value |
| −2 | 1 | 0 | +2 |
| −1 | 1 | 0 | +1 |
| 0 | 1 | 0 | Unchanged |
| 1 | 2 | 0, 2 | −1 |
| 2 | 4 | 0, 2, 3, 1 | −2 |

For example, the first indication information included in the first information fed back by the receiving end may be one of −2, −1, 0, 1, and 2 shown in table 1. In addition, it should be noted that, in this embodiment of this application, the feedback of the first indication information is determined by the receiving end based on the channel state. Whether the receiving end receives data is not limited. This is different from the conventional HARQ technology in which the receiving end feeds back the ACK/NACK based on the data decoding result.

In this case, the transmitting end may determine, based on the first indication information in the first information, whether to perform the retransmission or to adjust the transmission mode on the first channel. In the non-terrestrial communication network, a part of HARQ processes may be configured to be enabled, and a part of HARQ processes may be configured to be disabled. Optionally, the transmitting end may determine, based on the first indication information fed back by the receiving end, whether to retransmit data of the HARQ processes in the enabled state. Optionally, the transmitting end may determine, based on the first indication information fed back by the receiving end, a transmission mode of data related to the HARQ processes in the disabled state. In addition, for the data of the enabled HARQs and the data of the disabled HARQs, there may be different determining thresholds or criteria. For example, for the enabled HARQ process and the disabled HARQ process, different tables 1 may be set. In other words, correspondences between different channel condition levels and the configuration parameters of the transmission modes are set.

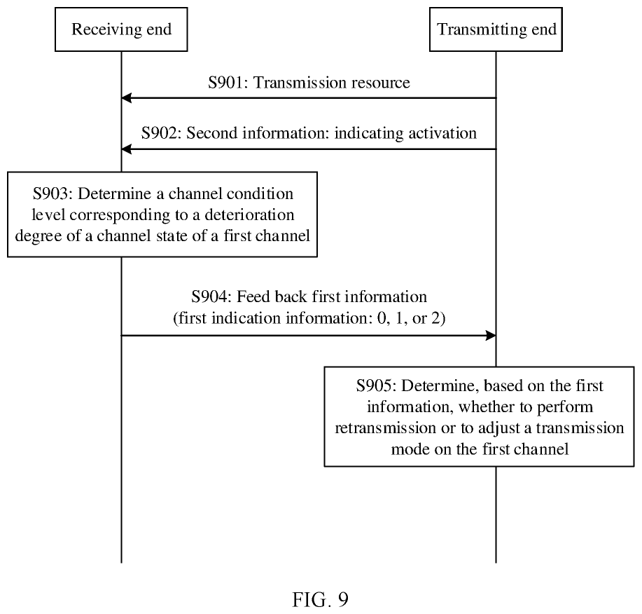

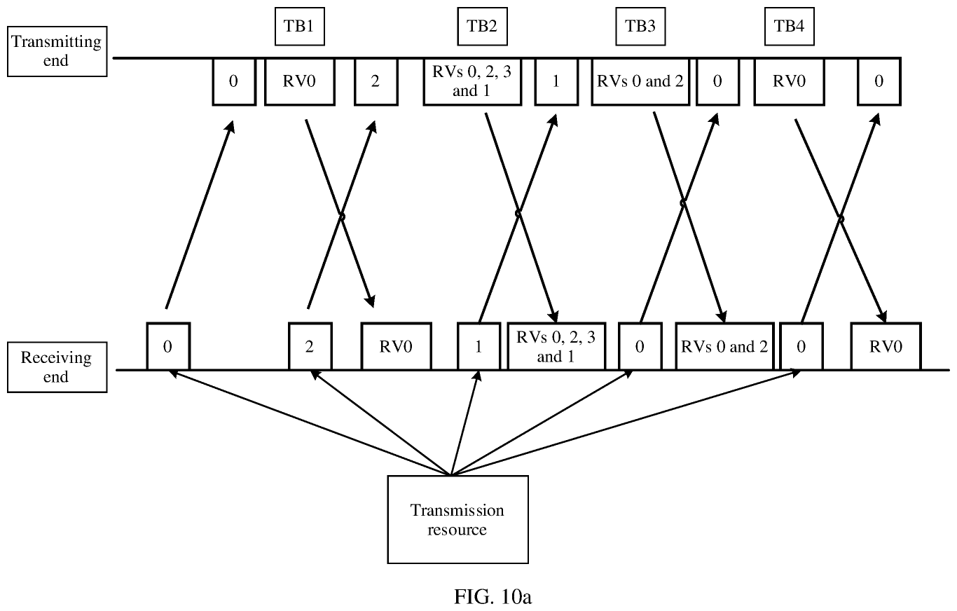

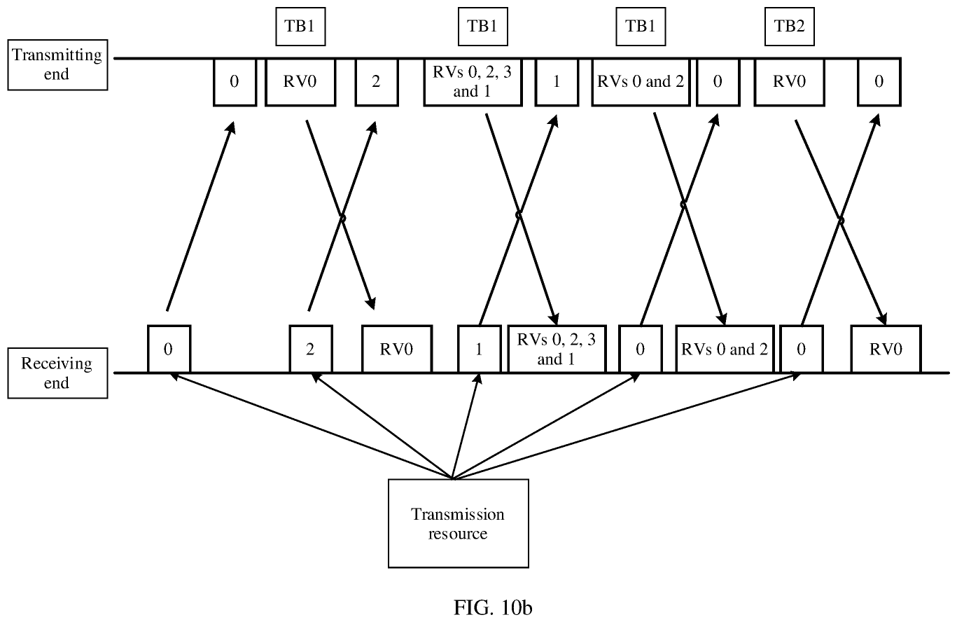

With reference to FIG. 9, FIG. 10a, and FIG. 10b, for the enabled HARQ processes and the disabled HARQ processes, the following describes in detail solutions in which the transmitting end determines the transmission mode based on the first indication information.

FIG. 9 is a flowchart of a data transmission method. The method includes the following steps.

S901: A receiving end obtains a transmission resource.

For a related implementation of the transmission resource, refer to S501. Details are not described in this embodiment of this application again. For example, FIG. 9 shows an implementation in which a transmitting end indicates the transmission resource to the receiving end.

S902: The receiving end obtains second information from the transmitting end, where the second information indicates that the transmission resource is to be activated for feedback. Optionally, S902 may not be performed, and S903 is directly performed after S901 is performed.

S903: The receiving end measures a channel state of a first channel. For example, the receiving end determines a deterioration degree of the channel state of the first channel, and determines to feed back first information to the transmitting end based on a measurement result, where the first information includes first indication information, and the first indication information is one of 0, 1, and 2.

Optionally, if having received first data from the transmitting end through the first channel, the receiving end may measure the channel state of the first channel based on the first data. The first data is related to a first hybrid automatic repeat request HARQ process, and the first HARQ process is in a disabled state. In this case, the first information to be fed back by the receiving end may be specifically used by the transmitting end for determining a transmission mode of to-be-sent second data, and the second data is related to the first HARQ. Optionally, the second data and the first data may be a same TB, but versions or version combinations are different. Alternatively, optionally, the second data and the first data are different TBs. The transmission mode of the second data includes at least one of the following: repeated transmission and aggregation transmission. In this embodiment of this application, data transmission in the disabled HARQ is enhanced, to resist a decoding error caused by a channel burst. This is applicable to a non-terrestrial network communication scenario.

Optionally, if the receiving end has received third data from the transmitting end through the first channel, the receiving end measures the channel state of the first channel based on the obtained third data. The third data is related to a second hybrid automatic repeat request HARQ process, and the second HARQ process is in an enabled state. In this case, the first information to be fed back by the receiving end may be specifically used by the transmitting end for determining whether to retransmit the third data. Optionally, if the third data packet includes a plurality of versions, retransmission of the third data may be transmission of a same version in previous transmission, may be aggregation transmission of a plurality of versions, or may be transmission for a plurality of times, namely, repeated transmission.

S904: The receiving end feeds back the first information to the transmitting end based on the transmission resource. As shown in FIG. 9, as an example, the first information fed back by the receiving end to the transmitting end includes a bit 0, 1, or 2.

S905: The transmitting end determines, based on the first information, whether to perform the retransmission or to adjust the transmission mode on the first channel.

Optionally, the receiving end side may also determine, based on content fed back by the receiving end side or an indication from the transmitting end, whether next obtained data is retransmitted data or new data. For example, when the receiving end is a terminal, and the transmitting end is a base station, the base station may indicate, to the terminal device in the DCI, whether the next obtained data is retransmitted data or new data.

For example, FIG. 10a is a schematic diagram of data transmission, and shows that aggregation transmission modes corresponding to different channel condition levels are different. It is assumed that a TB1, a TB2, a TB3, and a TB4 are data blocks, also referred to as transport blocks, that are related to a first HARQ process, and the first HARQ process is in a disabled state. When the first indication information is 0, it indicates that the channel condition level of the first channel is 0, and a version RV0 of the data is transmitted. When the first indication information is 1, it indicates that the channel condition level of the first channel is 1, and the version RV0 and a version RV2 of the data are transmitted. When the first indication information is 2, it indicates that the channel condition level of the first channel is 2, and the version RV0, the version RV2, a version RV3, and a version RV1 of the data, which are RVs 0, 2, 3, and 1 for short, are transmitted. As shown in FIG. 10a, when the receiving end feeds back 0 based on the transmission resource, the transmitting end sends an RV0 of the TB1. Before obtaining the RV0 of the TB1, the receiving end determines that a channel condition level corresponding to a deterioration degree of a state of a first channel reaches a level 2, and feeds back 2 based on the transmission resource. In this case, the transmitting end transmits, in advance, RVs 0, 2, 3, and 1 of data TB2 that is different from the TB1. Before obtaining the RVs 0, 2, 3, and 1 of the TB2, the receiving end determines that the channel condition level corresponding to the deterioration degree of the state of the first channel reaches a level 1, and then feeds back 1 based on the transmission resource. In this case, the transmitting end transmits an RV0 and an RV2 of the next data block TB3, and by analogy. FIG. 10a further shows a case in which the transmitting end receives the feedback 0 and continues to transmit an RV0 of the TB4.

For example, FIG. 10b is a schematic diagram of data block transmission. It is assumed that the TB1 and the TB2 are data blocks, also referred to as transport blocks, that are related to a second HARQ, and the second HARQ process is in an enabled state. When the first indication information is 0, it indicates that the channel condition level of the first channel is 0, and a version RV0 of the data is transmitted. When the first indication information is 1, it indicates that the channel condition level of the first channel is 1, and the version RV0 and a version RV2 of the data are transmitted. When the first indication information is 2, it indicates that the channel condition level of the first channel is 2, and the version RV0, the version RV2, a version RV3, and a version RV1 of the data, which are RVs 0, 2, 3, and 1 for short, are transmitted. As shown in FIG. 10b, when the receiving end feeds back 0 based on the transmission resource, the transmitting end sends an RV0 of the TB1. Before obtaining the RV0 of the TB1, the receiving end determines that a channel condition level corresponding to a deterioration degree of a state of a first channel reaches a level 2, and feeds back 2 based on the transmission resource. In this case, the transmitting end retransmits RVs 0, 2, 3, and 1 of the TB1 in advance. Before obtaining the RVs 0, 2, 3, and 1 of the TB1, the receiving end determines that the channel condition level corresponding to the deterioration degree of the state of the first channel reaches a level 1, and then feeds back 1 based on the transmission resource. In this case, the transmitting end retransmits the RV0 and the RV2 of the TB1, and by analogy. FIG. 10b further shows a case in which the transmitting end receives the feedback 0 and continues to transmit an RV0 of the TB2. Optionally, if the transmitting end has not received the feedback 0 from the receiving end when a quantity of retransmissions of the TB1 reaches a specified maximum quantity of retransmissions, the transmitting end may continue to transmit next data, and stop transmitting the TB1.

Solution (2): The first information fed back by the receiving end includes second indication information, where the second indication information indicates a modulation and coding scheme MCS or a variation value of an MCS.

In an optional implementation, the second indication information indicates the modulation and coding scheme MCS. The MCS is related to a CQI, an initial block error rate (initial block error rate, IBLER), inter-cell interference coordination (inter-cell interference coordination, ICIC), and the like. For example, CQI indexes are represented by 0 to 15, where 0 indicates the worst channel quality, and 15 indicates the best channel quality. The receiving end may measure a channel state of a first channel, to determine a first CQI index related to the first channel. Different CQI index values correspond to different MCSs. The second indication information may be specifically a first CQI index, and the first CQI index is one of 0 to 15. It should be noted that, in this embodiment of this application, the CQI index is fed back, so that the transmitting end determines an MCS used by the transmitting end for data transmission. In addition, the CQI index is fed back through a specific transmission resource. This is different from a manner of a conventional technology in which a terminal device reports a channel state information CSI report.

The receiving end feeds back the first CQI index to the transmitting end based on a measurement result of the channel state, to represent a recommended MCS that is used when the transmitting end transmits data to the receiving end. Optionally, MCSs corresponding to different CQI index values may be pre-defined. The following table 2 shows an MCS table corresponding to a target block error rate (BLER) of 0.01 or 0.001. The following table 3 shows an MCS table corresponding to a target block error rate (BLER) of 0.1. In this case, the transmitting end may distinguish, based on a current communication scenario, for example, a non-terrestrial network or a terrestrial network, target block error rates corresponding to first CQI indexes fed back by the receiving end, and the MCS tables corresponding to the target block error rates, and thus determine an MCS based on the first CQI index.

Therefore, for data related to a HARQ process in a disabled state, the transmitting end does not need to retransmit the data, and the MCS determined by the transmitting end based on the first CSI index may indicate a modulation manner and a code rate of to-be-sent data related to the HARQ process, for example, next data. For data related to a HARQ process in an enabled state, the MCS determined by the transmitting end based on the first CSI index may indicate a modulation manner and a code rate of retransmitted data related to the HARQ process.

TABLE 2

| CQI index | Modulation | Encoding (or code rate) | Efficiency |
|---|---|---|---|
| (CQI index) | modulation | (code rate × 1024) | efficiency |
| 0 | Out of range (out of range) | | |
| 1 | QPSK | 35 | 0.0689 |
| 2 | QPSK | 59 | 0.1149 |
| 3 | QPSK | 92 | 0.1792 |
| 4 | QPSK | 141 | 0.2758 |
| 5 | QPSK | 227 | 0.4435 |
| 6 | QPSK | 362 | 0.7078 |
| 7 | QPSK | 528 | 1.0318 |
| 8 | QPSK | 708 | 1.3833 |
| 9 | 16QAM | 445 | 1.7372 |
| 10 | 16QAM | 576 | 2.2519 |
| 11 | 16QAM | 725 | 2.8309 |
| 12 | 64QAM | 548 | 3.2124 |
| 13 | 64QAM | 667 | 3.9086 |
| 14 | 64QAM | 784 | 4.5909 |
| 15 | 64QAM | 908 | 5.3216 |

TABLE 3

| CQI index | Modulation | Encoding (or code rate) | Efficiency |
|---|---|---|---|
| (CQI index) | modulation | (code rate × 1024) | efficiency |
| 0 | Out of range (out of range) | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In another optional implementation, the second indication information indicates a variation value of a modulation and coding scheme MCS. The variation value of the MCS is a variation value relative to an MCS corresponding to the latest CQI fed back by the receiving end. The transmitting end may determine, based on the variation value of the MCS and an MCS corresponding to the latest CQI that is received by the transmitting end, the MCS that is used when the transmitting end transmits the data to the receiving end.

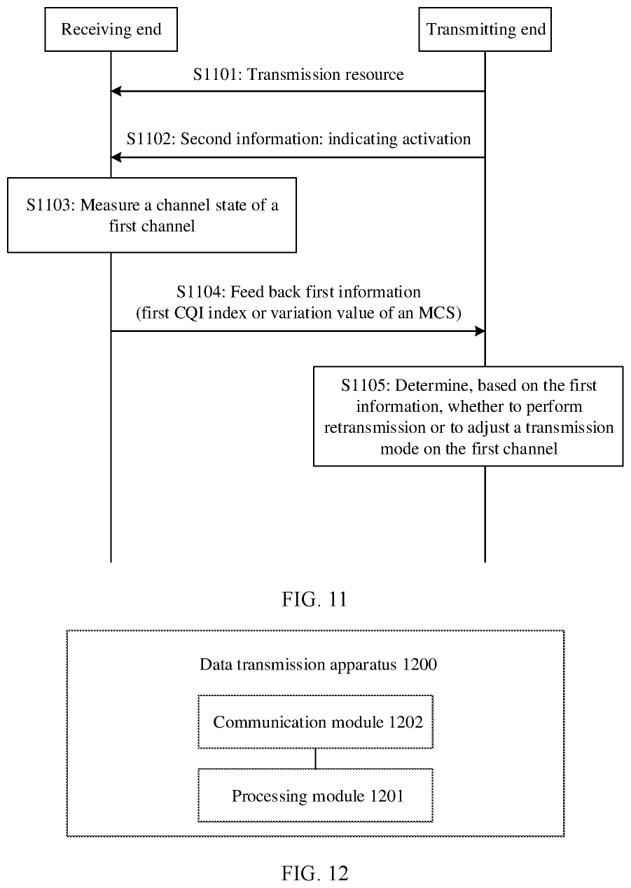

FIG. 11 is a flowchart of a data transmission method. The method includes the following steps.

S1101: A receiving end obtains a transmission resource.

For a related implementation of the transmission resource, refer to S501. Details are not described in this embodiment of this application again. For example, FIG. 9 shows an implementation in which a transmitting end indicates the transmission resource to the receiving end.

S1102: The receiving end obtains second information from the transmitting end, where the second information indicates that the transmission resource is to be activated for feedback. Optionally, S1102 may not be performed, and S1103 is directly performed after S1101 is performed.

S1103: The receiving end measures a channel state of a first channel, and determines, based on a measurement result, first information fed back to the transmitting end, where the first information includes second indication information, and the second indication information is a first CQI index for indicating an MCS, or the second indication information is a variation value of the MCS.

Optionally, if having received first data from the transmitting end through the first channel, the receiving end may measure the channel state of the first channel based on the first data. The first data is related to a first hybrid automatic repeat request HARQ process, and the first HARQ process is in a disabled state. In this case, the first information to be fed back by the receiving end may be specifically used by the transmitting end for determining a transmission mode of to-be-sent second data, and the second data is related to the first HARQ. Optionally, the second data and the first data may be a same TB, but versions or version combinations are different. Alternatively, optionally, the second data and the first data are different TBs. The transmission mode of the second data includes at least one of the following: repeated transmission and aggregation transmission. In this embodiment of this application, data transmission in the disabled HARQ is enhanced, to resist a decoding error caused by a channel burst. This is applicable to a non-terrestrial network communication scenario.

Optionally, if t having received third data from the transmitting end through the first channel, the receiving end measures the channel state of the first channel based on the obtained third data. The third data is related to a second hybrid automatic repeat request HARQ process, and the second HARQ process is in an enabled state. In this case, the first information to be fed back by the receiving end may be specifically used by the transmitting end for determining whether to retransmit the third data. Optionally, if the third data packet includes a plurality of versions, retransmission of the third data may be transmission of a same version in previous transmission, may be aggregation transmission of a plurality of versions, or may be transmission for a plurality of times, namely, repeated transmission.

S1104: The receiving end feeds back the first information to the transmitting end based on the transmission resource. As shown in FIG. 9, the first information fed back by the receiving end to the transmitting end includes the first CQI index or the variation value of the MCS.

S1105: The transmitting end determines, based on the first information, whether to perform the retransmission or to adjust the transmission mode on the first channel.

Therefore, for data related to a HARQ process in a disabled state, the transmitting end does not need to retransmit the data, and the MCS determined by the transmitting end based on the first CSI index may indicate a modulation manner and a code rate of to-be-sent data related to the HARQ process, for example, next data. For data related to a HARQ process in an enabled state, the MCS determined by the transmitting end based on the first CSI index may indicate a modulation manner and a code rate of retransmitted data related to the HARQ process.

Solution (3): The first information may include first indication information and second indication information. The transmitting end determines, based on the first information, a transmission mode, for example, whether to perform the retransmission or to adjust the transmission mode on the first channel. Solution (3) may be implemented with reference to solution 1, in combination with solution (2). Details are not described in this embodiment of this application again.

Further, on the basis of the foregoing embodiments, if the transmitting end is a base station, and the receiving end is a terminal device, information fed back by the terminal device in advance may be used as a reference when the base station schedules downlink data. Therefore, a related PDCCH may be omitted to reduce a downlink resource overhead. When the PDCCH exists, information fed back by a user may be used as a reference for downlink data scheduling. A data transmission mode used by the base station may be a manner fed back by the user, may be a manner indicated by the PDCCH, or may be a combination of the two.

Based on a same concept, refer to FIG. 12. An embodiment of this application provides a data transmission apparatus 1200. The apparatus 1200 includes a processing module 1201 and a communication module 1202. The communication apparatus 1200 may be a transmitting end, or may be an apparatus that is used in the transmitting end for supporting the transmitting end in performing a data transmission method. Alternatively, the communication apparatus 1200 may be a receiving end, or may be an apparatus that is used in the receiving end for supporting the receiving end in performing a data transmission method.

The communication module may also be referred to as a transceiver module, a transceiver, a transceiver machine, a transceiver apparatus, or the like. The processing module may also be referred to as a processor, a processing board, a processing unit, a processing apparatus, or the like. Optionally, a component that is in the communication module and that is configured to implement a receiving function may be considered as a receiving unit. It should be understood that the communication module is configured to perform a transmitting operation on the transmitting end side and a receiving operation on the receiving end side in the foregoing method embodiments. A component that is in the communication module and that is configured to implement a transmitting function is considered as a transmitting unit. In other words, the communication module includes the receiving unit and the transmitting unit. When the apparatus 1200 is used in the transmitting end, the receiving unit included in the communication module 1202 of the apparatus 1200 is configured to perform a receiving operation on the transmitting end side, for example, receiving first information from the receiving end. The transmitting unit included in the communication module 1202 of the apparatus 1200 is configured to perform a transmitting operation on the transmitting end side, for example, sending second information to the receiving end. When the apparatus 1200 is used in the receiving end, the receiving unit included in the communication module 1202 of the apparatus 1200 is configured to perform a receiving operation on the receiving end side, for example, receiving second information from the transmitting end. The transmitting unit included in the communication module 1202 of the apparatus 1200 is configured to perform a transmitting operation on the receiving end side, for example, sending first information to the transmitting end. In addition, it should be noted that, if the apparatus is implemented by using a chip/a chip circuit, the communication module may be an input/output circuit and/or a communication interface for performing an input operation (corresponding to the foregoing receiving operation) and an output operation (corresponding to the foregoing transmitting operation). The processing module is an integrated processor, a microprocessor, or an integrated circuit.

The following describes in detail an implementation in which the apparatus 1200 is used in the receiving end. The apparatus 1200 includes: the communication module 1202, configured to obtain a transmission resource; and the processing module 1201, configured to determine first information, where the first information is determined based on a channel state of a first channel, and the first information indicates whether retransmission is required or indicates whether a transmission mode is to be adjusted.

The communication module 1202 is further configured to feed back the first information to a transmitting end based on the transmission resource.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, before feeding back the first information to the transmitting end based on the transmission resource, the communication module 1202 is further configured to: obtain second information from the transmitting end, where the second information indicates that the transmission resource is to be activated for feedback.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

In an optional implementation, the communication module 1202 is specifically configured to: in a first time period, feed back the first information to the transmitting end based on the transmission resource, where the first time period indicates effective duration in which the transmission resource is used for feeding back the first information.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

In an optional implementation, the communication module 1202 is further configured to obtain first data from the transmitting end through the first channel, where the first data is related to a first hybrid automatic repeat request HARQ process, and the first HARQ process is in a disabled state. The processing module 1201 is further configured to measure the channel state of the first channel based on the obtained first data, and determine the first information based on a measurement result, where the first information is used by the transmitting end for determining a transmission mode of to-be-sent second data, and the second data is related to the first HARQ. Optionally, the transmission mode of the second data includes at least one of the following: repeated transmission and aggregation transmission.

In this embodiment of this application, data transmission in the disabled HARQ is enhanced, to resist a decoding error caused by a channel burst. This is applicable to a non-terrestrial network communication scenario.

In an optional implementation, the communication module 1202 is further configured to obtain third data from the transmitting end through the first channel, where the third data is related to a second hybrid automatic repeat request HARQ process, and the second HARQ process is in an enabled state. The processing module 1201 is further configured to measure the channel state of the first channel based on the obtained third data, and determine the first information based on a measurement result, where the first information is used by the transmitting end for determining whether to retransmit the third data. The first information is fed back before a decoding result is obtained, so that the transmitting end may determine, in advance based on the first information, whether to perform the retransmission, without waiting for an ACK/NACK indicating whether to perform the retransmission. This reduces the communication delay.

In an optional implementation, the first information includes at least one of the following: first indication information and second indication information. The first indication information indicates a channel condition of the first channel, and the second indication information indicates a modulation and coding scheme MCS or a variation value of an MCS.

In an optional implementation, the channel condition of the first channel is related to a deterioration degree of a channel state of the first channel. If the deterioration degree of the channel state of the first channel exceeds a specified threshold, the channel condition of the first channel is poor. Alternatively, if the deterioration degree of the channel state of the first channel does not exceed a specified threshold, the channel condition of the first channel is good. The feedback is performed in advance to briefly indicate the good or poor channel condition to the transmitting end. Therefore, efficiency of determining the transmission mode by the transmitting end can be further improved. For example, an adjustment is implemented in advance, and the communication delay is reduced.

In an optional implementation, the channel condition of the first channel is a channel condition level that is in a preset range of channel condition levels and that is related to the deterioration degree of the state of the first channel. The preset range of channel condition levels includes a plurality of channel condition levels, and different channel condition levels are associated with different deterioration degrees of the channel state. The channel condition levels are classified, so that different transmission modes are used for different channel conditions. This is more suitable for measuring the channel state, and data transmission can be effectively enhanced.

The following describes in detail an implementation in which the apparatus 1200 is used in the transmitting end. The apparatus 1200 includes: the communication module 1202, configured to obtain first information from a receiving end based on a transmission resource, where the first information is determined based on a channel state of a first channel, the first information indicates whether retransmission is required or indicates whether a transmission mode is to be adjusted, and the transmission resource is used for feeding back the first information; and the processing module 1201, further configured to determine, based on the first information, whether to perform the retransmission or to adjust the transmission mode on the first channel.

In this embodiment of this application, a specific transmission resource is configured, so that the receiving end feeds back the information related to the channel state to the transmitting end. Before receiving feedback obtained after data decoding, the transmitting end may determine the data transmission mode based on the information related to the channel state. The method can reduce a communication delay, be applied to a non-terrestrial communication system, and improve a throughput of the non-terrestrial communication system.

In an optional implementation, before obtaining the first information from the receiving end based on the transmission resource, the communication module 1202 is further configured to: send second information to the receiving end, where the second information indicates that the transmission resource is to be activated for feedback.

In this embodiment of this application, the transmitting end directly indicates activation of the transmission resource to the receiving end, to implement dynamic scheduling of the transmission resource. When no activation of the transmission resource is indicated, that is, the transmission resource is deactivated, the transmission resource may be used for normal data communication. This facilitates flexible resource scheduling when resources are insufficient.

In an optional implementation, the communication module 1202 is specifically configured to: in a first time period, obtain the first information from the receiving end based on the transmission resource, where the first time period indicates effective duration in which the transmission resource is used for feeding back the first information.

In this embodiment of this application, the first time period is set for indirectly reflecting the activation/deactivation of the transmission resource, to implement dynamic scheduling of the transmission resource. In a case of the deactivation, the transmission resource may be used for the normal data communication. This facilitates flexible resource scheduling when resources are insufficient.

In an optional implementation, the communication module 1202 is further configured to: before obtaining the first information from the receiving end, send first data to the receiving end through the first channel, where the first data is related to a first hybrid automatic repeat request HARQ process, and the first HARQ process is in a disabled state; and the first information is used by the transmitting end for determining a transmission mode of to-be-sent second data, and the second data is related to the first HARQ. Optionally, the transmission mode of the second data includes at least one of the following: repeated transmission and aggregation transmission.

In this embodiment of this application, data transmission in the disabled HARQ is enhanced, to resist a decoding error caused by a channel burst. This is applicable to a non-terrestrial network communication scenario.

In an optional implementation, the communication module 1202 is further configured to: before obtaining the first information from the receiving end, send third data to the receiving end through the first channel, where the third data is related to a second hybrid automatic repeat request HARQ process, and the second HARQ process is in an enabled state; and the first information is used by the transmitting end for determining whether to retransmit the third data. The first information is fed back before a decoding result is obtained, so that the transmitting end may determine, in advance based on the first information, whether to perform the retransmission, without waiting for an ACK/NACK indicating whether to perform the retransmission. This reduces the communication delay.

In an optional implementation, the first information includes at least one of the following: first indication information and second indication information. The first indication information indicates a channel condition of the first channel, and the second indication information indicates a modulation and coding scheme MCS or a variation value of an MCS.

In an optional implementation, the channel condition of the first channel is related to a deterioration degree of a channel state of the first channel. If the deterioration degree of the channel state of the first channel exceeds a specified threshold, the channel condition of the first channel is poor. Alternatively, if the deterioration degree of the channel state of the first channel does not exceed a specified threshold, the channel condition of the first channel is good. The feedback is performed in advance to briefly indicate the good or poor channel condition to the transmitting end. Therefore, efficiency of determining the transmission mode by the transmitting end can be further improved. For example, an adjustment is implemented in advance, and the communication delay is reduced.

In an optional implementation, the channel condition of the first channel is a channel condition level that is in a preset range of channel condition levels and that is related to the deterioration degree of the state of the first channel. The preset range of channel condition levels includes a plurality of channel condition levels, and different channel condition levels are associated with different deterioration degrees of the channel state. The channel condition levels are classified, so that different transmission modes are used for different channel conditions. This is more suitable for measuring the channel state, and data transmission can be effectively enhanced.

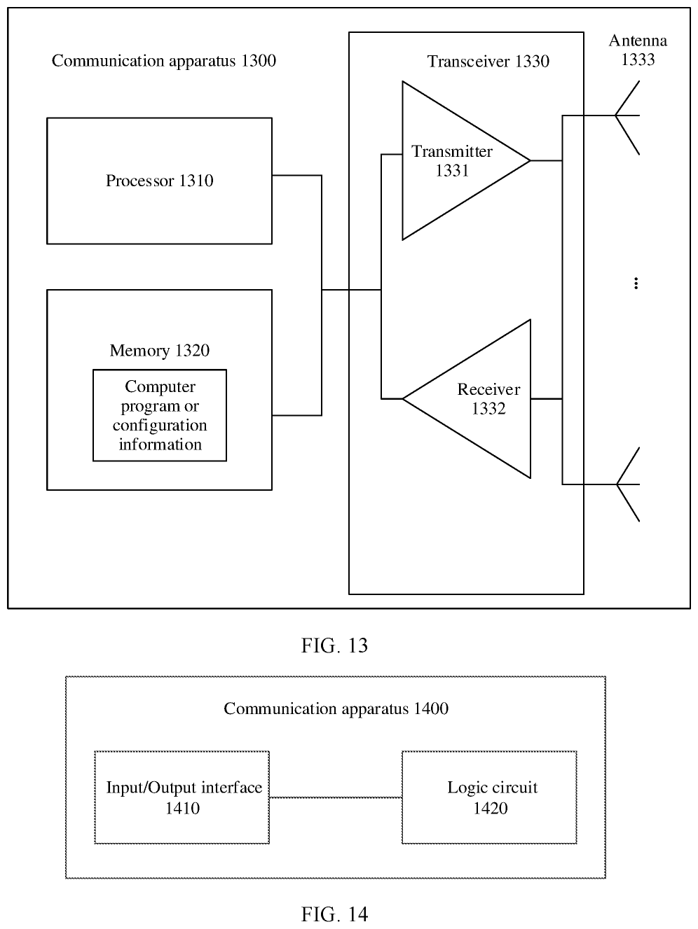

Based on a same concept, as shown in FIG. 13, an embodiment of this application provides a communication apparatus 1300. The communication apparatus 1300 may be a chip or a chip system. Optionally, in this embodiment of this application, the chip system may include a chip, or may include the chip and another discrete device.

The communication apparatus 1300 may include at least one processor 1310. The processor 1310 is coupled to a memory. Optionally, the memory may be located inside or outside the apparatus. For example, the communication apparatus 1300 may further include at least one memory 1320. The memory 1320 stores a computer program, configuration information, a computer program or instructions, and/or data required for implementing any one of the foregoing embodiments. The processor 1310 may execute the computer program stored in the memory 1320, to complete the method in any one of the foregoing embodiments.

The coupling in this embodiment of this application may be an indirect coupling or a communication connection between apparatuses, units, or modules in an electrical form, a mechanical form, or another form, and is used for information exchange between the apparatuses, the units, or the modules. The processor 1310 may operate with the memory 1320. A specific connection medium between a transceiver 1330, the processor 1310, and the memory 1320 is not limited in this embodiment of this application.

The communication apparatus 1300 may further include the transceiver 1330, and the communication apparatus 1300 may exchange information with another device by using the transceiver 1330. The transceiver 1330 may be a circuit, a bus, a transceiver, or any other apparatus that may be configured to exchange information, or may be referred to as a signal transceiver unit. As shown in FIG. 13, the transceiver 1330 includes a transmitter 1331, a receiver 1332, and an antenna 1333. In addition, when the communication apparatus 1300 is a chip-type apparatus or circuit, the transceiver in the apparatus 1300 may also be an input/output circuit and/or a communication interface for inputting data (also referred to as receiving data) and outputting data (also referred to as transmitting data). The processor is an integrated processor, a microprocessor, or an integrated circuit, and the processor may determine output data based on input data.

In a possible implementation, the communication apparatus 1300 may be used in a transmitting end. Specifically, the communication apparatus 1300 may be a transmitting end, or may be an apparatus that can support the transmitting end in implementing a function of the transmitting end in any one of the foregoing embodiments. The memory 1320 stores a computer program, a computer program or instructions, and/or data required for implementing the function of the transmitting end in any one of the foregoing embodiments. The processor 1310 may execute the computer program stored in the memory 1320, to implement the method performed by the transmitting end in any one of the foregoing embodiments. The transmitter 1331 in the communication apparatus 1300 is used in the transmitting end and may be configured to send transmission control configuration information to the receiving end through the antenna 1333. The receiver 1332 may be configured to receive, through the antenna 1333, transmission information sent by the receiving end.

In a possible implementation, the apparatus 1300 may be used in a receiving end. Specifically, the apparatus 1300 may be a receiving end, or may be an apparatus that can support the receiving end in implementing a function of the receiving end in any one of the foregoing embodiments. The memory 1320 stores a computer program, a computer program or instructions, and/or data required for implementing the function of the receiving end in any one of the foregoing embodiments. The processor 1310 may execute the computer program stored in the memory 1320, to implement the method performed by the receiving end in any one of the foregoing embodiments. The receiver 1332 in the communication apparatus 1300 is used in the receiving end and may be configured to receive, through the antenna 1333, transmission control configuration information sent by the transmitting end. The transmitter 1331 may be configured to send transmission information to the transmitting end through the antenna 1333.

The communication apparatus 1300 provided in this embodiment may be used in the transmitting end to complete the method performed by the transmitting end, or may be used in the receiving end to complete the method performed by the receiving end. Therefore, for technical effects that can be achieved by the communication apparatus 1300, refer to the foregoing method embodiments. Details are not described herein again.

In the embodiment of this application, the processor may be a general-purpose processor, a digital signal processor, an application-specific integrated circuit, a field programmable gate array or another programmable logic device, a discrete gate or transistor logic device, or a discrete hardware component, and may implement or perform the methods, steps, and logical block diagrams disclosed in embodiments of this application. The general-purpose processor may be a microprocessor or any conventional processor or the like. The steps of the method disclosed with reference to embodiments of this application may be directly performed by a hardware processor, or may be performed by using a combination of hardware in the processor and a software module.

In embodiments of this application, the memory may be a nonvolatile memory, for example, a hard disk drive (hard disk drive, HDD) or a solid-state drive (solid-state drive, SSD), or may be a volatile memory (volatile memory) such as a random-access memory (random-access memory, RAM). The memory may alternatively be any other medium that can be configured to carry or store expected program code in a form of an instruction or a data structure and that can be accessed by a computer. This is not limited thereto. The memory in this embodiment of this application may alternatively be a circuit or any other apparatus that can implement a storage function, and is configured to store a computer program, a computer program or instructions, and/or data.

Based on the foregoing embodiment, refer to FIG. 14. An embodiment of this application further provides another communication apparatus 1400, including an input/output interface 1410 and a logic circuit 1420. The input/output interface 1410 is configured to receive code instructions and transmit the code instructions to the logic circuit 1420. The logic circuit 1420 is configured to run the code instructions to perform the method performed by the transmitting end or the method performed by the receiving end in any one of the foregoing embodiments.

The communication apparatus 1400 may be used in a receiving end, to perform the method performed by the receiving end. The input/output interface 1410 is configured to input a transmission resource. The logic circuit 1420 is configured to determine first information. The first information is determined based on a channel state of a first channel. The first information indicates whether retransmission is required or indicates whether a transmission mode is to be adjusted. The input/output interface 1410 is further configured to output the first information through the transmission resource.

The communication apparatus 1400 may be used in a transmitting end, to perform the method performed by the transmitting end. In an optional implementation, the input/output interface 1410 is configured to input first information through the transmission resource. The first information is determined based on the channel state of the first channel. The first information indicates whether the retransmission is required or indicates whether the transmission mode is to be adjusted. The transmission resource is used for feeding back the first information. The logic circuit 1420 is configured to determine, based on the first information, whether to perform the retransmission or to adjust the transmission mode on the first channel.

The communication apparatus 1400 provided in this embodiment may be used in the transmitting end, to perform the method performed by the transmitting end, or may be used in the receiving end, to perform the method performed by the receiving end. Therefore, for technical effects that can be achieved by the communication apparatus 1400, refer to the foregoing method embodiments. Details are not described herein again.

Based on the foregoing embodiments, an embodiment of this application further provides a communication system. The communication system includes at least one communication apparatus used in a transmitting end and at least one communication apparatus used in a receiving end. For technical effects that can be achieved by the communication system, refer to the foregoing method embodiments. Details are not described herein again.

Based on the foregoing embodiments, an embodiment of this application further provides a computer-readable storage medium. The computer-readable storage medium stores a computer program or instructions. When the instructions are executed, the method performed by the transmitting end in any one of the embodiments is implemented, or the method performed by the receiving end is implemented. The computer-readable storage medium may include any medium that can store program code, such as a USB flash drive, a removable hard disk, a read-only memory, a random access memory, a magnetic disk, or an optical disc.

To implement the functions of the communication apparatuses in FIG. 13 and FIG. 14, an embodiment of this application further provides a chip, including a processor, to support the communication apparatuses in implementing the function of the transmitting end or the receiving end in the foregoing method embodiments. In a possible design, the chip is connected to a memory or the chip includes a memory, and the memory is configured to store a computer program or instructions and data that are necessary for the communication apparatus.

A person skilled in the art should understand that the embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to the embodiments of this application. It should be understood that a computer program or instructions may be used for implementing each procedure and/or each block in the flowcharts and/or the block diagrams and a combination of procedures and/or blocks in the flowcharts and/or the block diagrams. These computer programs or the instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer programs or the instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer programs or the instructions may alternatively be loaded onto a computer or another programmable data processing device, so that a series of operations and steps are performed on the computer or another programmable device, to generate computer-implemented processing. Therefore, the instructions executed on the computer or another programmable device provide steps for implementing a specific function in one or more procedures in the flowcharts and/or in one or more blocks in the block diagrams.

It is clear that a person skilled in the art can make various modifications and variations to embodiments of this application without departing from the scope of embodiments of this application. This application is intended to cover these modifications and variations provided that they fall within the scope of protection defined by the following claims and their equivalent technologies.

1. A data transmission method, applied to a receiving end, wherein the method comprises:
obtaining a transmission resource; and
feeding back first information to a transmitting end based on the transmission resource, wherein the first information is determined based on a channel state of a first channel, and the first information indicates whether retransmission is required or indicates whether a transmission mode is to be adjusted.

2. The method according to claim 1, wherein before the feeding back first information to a transmitting end based on the transmission resource, the method further comprises:
obtaining second information from the transmitting end, wherein the second information indicates that the transmission resource is to be activated for feedback.

3. The method according to claim 1, wherein the feeding back first information to a transmitting end based on the transmission resource comprises:
in a first time period, feeding back the first information to the transmitting end based on the transmission resource, wherein the first time period indicates effective duration in which the transmission resource is used for feeding back the first information.

4. The method according to claim 1, wherein the method further comprises:
obtaining first data from the transmitting end through the first channel, wherein the first data is related to a first hybrid automatic repeat request (HARQ) process, and the first HARQ process is in a disabled state;
measuring the channel state of the first channel based on the obtained first data; and
determining the first information based on a measurement result, wherein the first information is used by the transmitting end for determining a transmission mode of to-be-sent second data, and the second data is related to the first HARQ.

5. The method according to claim 4, wherein the transmission mode of the second data comprises at least one of repeated transmission or aggregation transmission.

6. The method according to claim 1, wherein the method further comprises:
obtaining third data from the transmitting end through the first channel, wherein the third data is related to a second hybrid automatic repeat request (HARQ) process, and the second HARQ process is in an enabled state;
measuring the channel state of the first channel based on the obtained third data; and
determining the first information based on a measurement result, wherein the first information is used by the transmitting end for determining whether to retransmit the third data.

7. The method according to claim 1, wherein:
the first information comprises at least one of first indication information or second indication information;
the first indication information indicates a channel condition of the first channel; and
the second indication information indicates a modulation and coding scheme (MCS) or a variation value of an MCS.

8. The method according to claim 7, wherein:
the channel condition of the first channel is related to a deterioration degree of the channel state of the first channel; and
if the deterioration degree of the channel state of the first channel exceeds a specified threshold, the channel condition of the first channel is poor; or
if the deterioration degree of the channel state of the first channel does not exceed a specified threshold, the channel condition of the first channel is good.

9. The method according to claim 7, wherein the channel condition of the first channel is a channel condition level that is in a preset range of channel condition levels and that is related to a deterioration degree of the channel state of the first channel, the preset range of channel condition levels comprises a plurality of channel condition levels, and different channel condition levels are associated with different deterioration degrees of the channel state.

10. A method, applied to a transmitting end, wherein the method comprises:
obtaining first information from a receiving end based on a transmission resource, wherein the first information is determined based on a channel state of a first channel, the first information indicates whether retransmission is required or indicates whether a transmission mode is to be adjusted, and the transmission resource is used for feeding back the first information; and
determining, based on the first information, whether to perform the retransmission or to adjust the transmission mode on the first channel.

11. The method according to claim 10, wherein before the obtaining first information from a receiving end based on a transmission resource, the method further comprises:
sending second information to the receiving end, wherein the second information indicates that the transmission resource is to be activated for feedback.

12. The method according to claim 10, wherein the obtaining first information from a receiving end based on a transmission resource comprises:
in a first time period, obtaining the first information from the receiving end based on the transmission resource, wherein the first time period indicates effective duration in which the transmission resource is used for feeding back the first information.

13. The method according to claim 10, wherein the method further comprises:
before the obtaining first information from a receiving end, sending first data to the receiving end through the first channel, wherein the first data is related to a first hybrid automatic repeat request (HARQ) process, the first HARQ process is in a disabled state, and the first information is used by the transmitting end for determining a transmission mode of to-be-sent second data, and the second data is related to the first HARQ.

14. The method according to claim 13, wherein the transmission mode of the second data comprises at least one of repeated transmission or aggregation transmission.

15. The method according to claim 10, wherein the method further comprises:
before the obtaining first information from a receiving end, sending third data to the receiving end through the first channel, wherein the third data is related to a second hybrid automatic repeat request (HARQ) process, the second HARQ process is in an enabled state, and the first information is used by the transmitting end for determining whether to retransmit the third data.

16. The method according to claim 10, wherein:
the first information comprises at least one of first indication information or second indication information;
the first indication information indicates a channel condition of the first channel; and
the second indication information indicates a modulation and coding scheme (MCS) or a variation value of an MCS.

17. The method according to claim 16, wherein:
the channel condition of the first channel is related to a deterioration degree of the channel state of the first channel; and
if the deterioration degree of the channel state of the first channel exceeds a specified threshold, the channel condition of the first channel is poor; or
if the deterioration degree of the channel state of the first channel does not exceed a specified threshold, the channel condition of the first channel is good.

18. The method according to claim 16, wherein the channel condition of the first channel is a channel condition level that is in a preset range of channel condition levels and that is related to a deterioration degree of the channel state of the first channel, the preset range of channel condition levels comprises a plurality of channel condition levels, and different channel condition levels are associated with different deterioration degrees of the channel state.

19. An apparatus, used in a receiving end, wherein the apparatus comprises:
a transceiver, the transceiver configured to obtain a transmission resource;
at least one processor; and
one or more memories coupled to the at least one processor and storing programming instructions for execution by the at least one processor to determine first information, wherein the first information is determined based on a channel state of a first channel, and the first information indicates whether retransmission is required or indicates whether a transmission mode is to be adjusted; and
wherein the transceiver is further configured to feed back the first information to a transmitting end based on the transmission resource.

20. The apparatus according to claim 19, wherein before feeding back the first information to the transmitting end based on the transmission resource, the transceiver is further configured to:
obtain second information from the transmitting end, wherein the second information indicates that the transmission resource is to be activated for feedback.
